(19) United States
(12) Patent Application Publication
(10) Pub. No.: US 2019/0166881 A1
(43) Pub. Date: Jun. 6, 2019

(54) ANIMAL FEED PELLETS INCLUDING A FEED ADDITIVE, METHOD OF MAKING AND OF USING SAME

(71) Applicant: Prevtec Microbia Inc., Montreal (CA)

(72) Inventor: Eric Nadeau, Otterburn Park (CA)

(73) Assignee: Prevtec Microbia Inc., Montreal, QC (CA)

(21) Appl. No.: 16/309,890

(22) PCT Filed: Jun. 14, 2017
(86) PCT No.: PCT/CA2017/050730

§ 371 Date: Dec. 13, 2018

Related U.S. Application Data
(60) Provisional application No. 62/349,843, filed on Jun. 14, 2016.

(51) Int. Cl. A23K 40/30; A23K 10/18; A23K 20/142; A23K 20/163; A23K 40/20; A23K 50/10; A23K 50/30; A23K 50/60; A23K 50/75

(52) U.S. Cl. CPC A23K 40/30; A23K 10/18; A23K 20/142; A23K 20/163; A23K 40/20; A23K 50/10; A23V 2250/5026; A23K 50/60; A23K 50/75; A23V 2002/00; A23V 2250/0618; A23V 2250/628; A23V 2250/636; A23K 50/30

(57) ABSTRACT

There is provided an animal feed pellet comprising viable non-pathogenic E. coli bacteria incorporated into the feed pellet in an amount sufficient for affording a benefit to an animal having ingested the animal feed. There is also provided methods of making same and uses thereof.

### CROSS-REFERENCE TO RELATED APPLICATION

The present application claims the benefit of U.S. provisional patent application Ser. No. 62/349,843 filed on Jun. 14, 2016 by Eric Nadeau. The contents of the above-referenced document are incorporated herein by reference in their entirety.

### TECHNICAL FIELD

This application generally relates to the field of animal feed pellets including a feed additive, to methods of making same and to uses thereof.

### BACKGROUND

Pelleted animal feeds are typically defined as agglomerated feeds formed by extruding individual ingredients or mixtures by compacting and forcing through die openings by any mechanical process. Basically, the purpose of pelleting is to take a finely divided, sometimes dusty, unpalatable and difficult-to-handle feed material and, by using high heat, moisture (steam-conditioning) and pressure, form it into larger particles.

There is a wide range of conditioning temperature and retention time combinations used in the commercial feed milling (McCracken, Poultry Feeds, Supply, Composition and Nutritive Value, CAB International, New York (2002), pp. 301-316) and typically, pelleting process involves hostile heat, moisture and pressure conditions so as to control feed borne pathogens, such as salmonella and Escherichia coli (E. coli). At current industry practices, for example, the conditioner temperatures in some feed mills may reach 90° C., with the feed industry tending to move to even higher and harsher feed processing conditions to control the feed borne pathogens.

Probiotic supplementation incorporated into animal feed pellets is possible with bacteria strains that are heat-stable and shelf-stable since, otherwise, bacteria instability over the pelleting harsh pressure, temperature and moisture conditions would pose a problem to their use in pelleted feed.

For example, strains that can exist in spore form can be useful for incorporating into animal feed pellets. Bacterial spores are dormant life forms which help bacteria survive by being resistant to extreme changes in the bacteria's habitat including extreme temperatures, lack of moisture/drought, or being exposed to chemicals and radiation. Bacterial spores can thus be helpful when attempting to incorporate probiotics into animal feed pellets. Most spore-forming bacteria are contained in the bacillus and clostridium species.

Probiotic strains that are not spore forming are typically not incorporated into the pellets but are rather coated onto the pellets, i.e., after submitting pellet ingredients to the above harsh conditions. For example, WO 2011/094469 describes preparation of probiotic pet food and of fish feed, where feed pellets are first sprayed with a fat-based moisture barrier, then put into contact with a dry composition containing the probiotics, and finally sprayed with an additional coat of the fat-based moisture barrier, such that the amount of coating on the surface of the feed pellet is about 10%-15% (wt/wt).

### SUMMARY

This Summary is provided to introduce a selection of concepts in a simplified form that are further described below in the Detailed Description. This Summary is not intended to identify key aspects or essential aspects of the claimed subject matter.

As embodied and broadly described herein, the present disclosure relates to an animal feed pellet including viable non-pathogenic E. coli incorporated into the pellet. The E. coli is an amount sufficient to afford a beneficial effect to an animal having ingested the animal feed. E. coli are microbes that are not typically associated with foods; it is thus not routine and conventional for E. coli to be voluntarily included in the animal feed.

As discussed previously, pelleting conditions used in the industry are designed to submit the feed ingredients to harsh conditions so as to control (i.e., kill) pathogens, such as salmonella and E. coli. In one embodiment, the present disclosure proposes a way to mitigate the effects of the necessary harsh conditions so as to afford incorporating non-pathogenic E. coli bacteria into the feed pellets while still controlling pathogens.

In one embodiment, the animal feed pellet comprises at least 1×10⁵ CFU/g of viable non-pathogenic E. coli bacteria incorporated into the pellets.

In one embodiment, the viable non-pathogenic E. coli is embedded in a feed additive. The feed additive is then incorporated into the animal feed pellet. In practical embodiments, the feed additive may be incorporated into the animal feed in various forms. For example, the feed additive may be co-extruded with the animal feed, or encapsulated within the animal feed, and the like. The person of skill will readily recognize that various ways of incorporating the feed additive into the animal feed may be used within the context of the present disclosure.

As embodied and broadly described herein, the present disclosure also relates to a feed additive for incorporating a viable non-pathogenic E. coli into an animal feed pellet, the feed additive comprising the non-pathogenic E. coli embedded in a matrix, wherein the matrix has a water activity (a_{w}) of ≤0.3 prior to incorporation into the pellet. The matrix comprises a hydrocolloid-forming polysaccharide.

In a non-limiting embodiment, the feed additive further includes one or more of the following set of features:
The matrix may include a second polysaccharide which is different from the hydrocolloid-forming polysaccharide. Optionally, the matrix may include a disaccharide.
The matrix may include a coating disposed on at least a portion of a surface thereof.
The matrix may include pores.
The coating may include a second polysaccharide which is different from the hydrocolloid-forming polysaccharide. Optionally, the coating may include a disaccharide.
The coating may include particulate calcium-containing compound.
The matrix may include pores and the coating may be disposed on at least a surface defining the pores.

The person of skill will readily recognize that embodiments of the feed additive may include any combinations of the features described above.

In the above embodiments, the person of skill will readily recognize that the matrix may include one or more elements, which are suitable for animal consumption and/or which are compatible with the non-pathogenic E. coli.

In a non-limiting embodiment, the feed additive comprises at least 1×10⁶ CFU/g of the E. coli. For example, the feed additive may include at least 1×10′ CFU/g, at least 1×10⁸ CFU/g, at least 1×10⁹ CFU/g, at least 1×10¹⁰ CFU/g, at least 1×10¹¹ CFU/g.

In a non-limiting embodiment, the feed additive is in the form of particles. In a practical implementation, at least a portion of the particles may form an aggregate of particles held together by a bridge comprising the coating as described previously.

In one practical non-limiting embodiment, the herein described particulate calcium-containing compound includes calcium lactate.

In a non-limiting embodiment, the feed additive may include one or more elements which afford conventional storage/shipping conditions as feed additive and/or when incorporated into the animal feed, without significant detrimental effect to bacteria cell viability and/or functional characteristics. In other words, even if in a particular embodiment the non-pathogenic E. coli may have a natural counter-part, the latter would suffer from conventional storage/shipping conditions such that it would result in significant reduction in bacteria cell viability and/or loss of functional characteristics. Accordingly, the feed additive described herein may stabilize the E. coli and preserve its activity for an extended period under conventional storage/shipping conditions, e.g., which may include for example conditions at or above ambient temperature and relative humidity. Examples of such elements are further discussed elsewhere in this text.

In an additional or alternative embodiment, the feed additive may include one or more elements such that the E. coli have markedly changed properties as compared to naturally occurring E. coli, for example but without being limited to, at least one of the following:
the feed additive may include one or more cryo-preservatives which may favorably allow freeze-drying or freezing of the E. coli during preparation and/or storage of the feed additive without significant reduction in bacteria cell viability and/or loss of functional characteristics;
the feed additive may include one or more elements that may positively affect the organoleptic properties, such that upon incorporating into the animal feed, the animal feed may have a more pleasant mouthfeel compared to the naturally occurring non-pathogenic E. coli in a composition devoid of such one or more elements. For example, a feed additive that would include a non-pathogenic E. coli mixed with culture broth would have a typical foul smell/taste, which may rebut the animal and thus significantly render more difficult the administration of the feed whereas the presence of one or more elements that positively affect the organoleptic properties may camouflage or neutralize such foul smell/taste;
the feed additive may include one or more elements that may affect the form of the E. coli formulation (e.g., transform into gel-like spreadable consistency and/or porous solid or semi-solid structure, etc.), which may facilitate incorporation of the E. coli into the animal feed when pelleting;
the feed additive may be in the form of particles having a customizable particle size, where a custom size or size ranges may be selected to obtain a desired result. For instance, a first population of particles may be selected to have a first mean diameter size, and a second population of particles may be selected to have a second mean diameter size. The first mean diameter size and the second mean diameter size may be different, i.e., have a size ratio (first:second)>1. The person of skill will recognize that such particle size distribution may result in a dissolution rate that is customizable to obtain a desired result.

The person of skill will readily recognize that embodiments of the feed additive may include any combinations of the features described above.

The above embodiments represent non-limiting examples of altered properties which may demonstrate a marked difference in characteristics compared to those of naturally occurring E. coli, because they result in an animal feed pellet being distinct from its natural counterparts in a way that is relevant to the nature of the present invention.

In a non-limiting embodiment, the customizable particle size may afford obtaining an increased and/or consistent dissolution rate of dried E. coli, as opposed to corresponding slow and inconsistent dissolution rate of naturally occurring dried E. coli. Indeed, a customized dissolution rate may be obtained based on the selection of an appropriate particle size ratio between the first and the second population of particles.

In a non-limiting embodiment, the customizable particle size may afford obtaining a time-release delivery of the non-pathogenic strain, as opposed to a burst delivery of naturally occurring E. coli, or of E. coli administered in other forms (for example, in drinking water). Such time-release delivery may be based on customizing the ratio of large/small particles such that overall, the E. coli is protected from the harsh intestinal tract environment for a pre-determined period of time. In turn, the controlled delivery timing of the E. coli can afford delivery at a pre-selected location along the intestinal tract. In other words, the person of skill may select a particular particle size distribution to afford a given time-release of the E. coli such that when factoring various factors affecting the intestinal transit, the E. coli can be mainly delivered in pre-determined portions of the intestinal tract.

As embodied and broadly described herein, the present disclosure also relates to a system for incorporating the herein described feed additive into the animal feed pellet. The system may include a user interface for allowing a user to control the amount of bacteria incorporated into the animal feed or an amount of bacteria to present to each animal feed wagon and/or feed system. This may be obtained by one or more of the following non-limiting practical implementations:
activating a pre-determined amount of live but dormant bacteria embedded in the feed additive. This can be achieved, for example, by addition of a suitable activating agent (such as, without being limited to, moisture, sugar, and the like) to a predetermined amount of bacteria/feed additive. Subsequently, the feed additive may be incorporated into the animal feed to obtain a pellet. The pellet can then be delivered to an animal feed system and/or animal feed wagon;
selecting particular ratios of particles of feed additive to be incorporated into the animal feed pellet. In such practical implementation, the particles may include a first population of particles having a first amount (colony-forming units, “CFU”) of viable non-pathogenic bacteria and a second population of particles having a second CFU of said viable non-pathogenic bacteria.

As embodied and broadly described herein, the present disclosure also relates to a kit for forming the herein described feed additive. The kit comprises in a first vial, the herein described first hydrocolloid-forming polysaccharide, in a separate second vial, the herein described E. coli, in a separate third vial, the herein described second polysaccharide which is different from the first polysaccharide, and in a separate fourth vial, the herein described disaccharide. Optionally, one of the herein described second, third and/or fourth vial may further include a calcium salt. In another option, the calcium salt may be included in a separate fifth vial.

The person of skill in the art will readily understand that the kit described previously may include one or more of the listed elements present in the same vial, subject to being compatible to being included as such.

In one non-limiting embodiment, the herein described disaccharide includes sucrose, trehalose, or a combination thereof.

In a non-limiting embodiment, the herein described calcium salt may include calcium lactate.

As embodied and broadly described herein, the present disclosure also relates to a method for preparing an animal feed pellet, comprising: providing ingredients for making the feed pellet and a feed additive, the feed additive including viable non-pathogenic E. coli; pelleting the ingredients and the feed additive to obtain the animal feed pellet.

In a non-limiting embodiment, the step of providing the feed additive includes providing feed additive in the form of particles, wherein the particles have a first population of particles having a first mean diameter size and a second population of particles having a second mean diameter size.

As embodied and broadly described herein, the present disclosure also relates to a method for forming the herein described feed additive. The method comprises providing particles which include a first polysaccharide which is a hydrocolloid-forming polysaccharide, a second polysaccharide which is different from the first polysaccharide, and a disaccharide which includes sucrose, trehalose, or a combination thereof, and the herein described E. coli. The method also comprises drying the particles to obtain a water activity (a_{w}) of ≤0.3.

In a non-limiting embodiment, the step of providing the particles comprises mixing the E. coli with the first polysaccharide to form a mixture; forming particles from the mixture; and contacting the particles with a preservation solution comprising the sucrose or trehalose, and the second polysaccharide.

In another non-limiting embodiment, the step of providing the particles comprises mixing the E. coli with the first polysaccharide and with the preservation solution comprising the sucrose or trehalose, and the second polysaccharide to form a mixture; and forming particles from the mixture.

In one embodiment, the animal feed pellet is for consumption by any one of poultry, pig, and cattle.

All features of embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

A detailed description of specific embodiments is provided herein below with reference to the accompanying drawings in which:

FIG. 1 shows a non-limiting flow diagram for preparing a bacteria culture in accordance with an embodiment of the present disclosure.

FIG. 2 shows a non-limiting flow diagram for drying beads with embedded E. coli in accordance with an embodiment of the present disclosure.

FIG. 3 shows a non-limiting diagram of a system for dispensing a feed additive in accordance with an embodiment of the present disclosure.

FIG. 4 shows a non-limiting bar graph that depicts the effect of preservation solutions S1, S2, S3 and S4 on bacterial viability following air-drying in accordance with an embodiment of the present disclosure.

FIG. 5 shows a non-limiting bar graph that depicts the effect of preservation solutions S1, S5, S6 and S7 on bacterial viability following air-drying in accordance with an embodiment of the present disclosure.

FIG. 6 shows a non-limiting bar graph that depicts the effect of preservation solutions S1, S0, S8 and S9 on bacterial viability following air-drying in accordance with an embodiment of the present disclosure.

FIG. 7 shows a non-limiting bar graph that depicts the effect of preservation solutions S1, S10, S11 and S12 on bacterial viability following air-drying in accordance with an embodiment of the present disclosure.

FIG. 8 shows a non-limiting bar graph that depicts the effect of preservation solutions S1, S13, S14 and S15 on bacterial viability following air-drying in accordance with an embodiment of the present disclosure.

FIG. 9 shows a non-limiting bar graph that depicts the effect of preservation solutions S1, S16, S17 and S18 on bacterial viability following air-drying in accordance with an embodiment of the present disclosure.

FIG. 10 shows a non-limiting bar graph that depicts the effect of preservation solutions S1 and S19 on bacterial viability following air-drying in accordance with an embodiment of the present disclosure.

FIGS. 11A, 11B, and 11C show the raw data represented in FIGS. 4 to 10.

FIG. 12 shows a non-limiting graphical representation of the CFU stability in dried particle beads over a period of time of 24 weeks. Black and white fill circles are results from two different batch productions that used the same manufacturing process.

FIG. 13 shows a non-limiting bar graph that depicts the average weight gain (Kg) after 7 days of pigs fed with an animal feed incorporating a feed additive in accordance with an embodiment of the present disclosure (IP) and with an animal feed without feed additive (“CP”). Bar errors depict the standard error (p=0.044).

FIG. 14 shows a non-limiting bar graph that depicts the average daily weight gain (g/day) during 7 days of the pigs from FIG. 13. Bar errors depict the standard error (p=0.044).

FIG. 15 shows a cross section of a feed additive particle in accordance with an embodiment of the present disclosure.

FIG. 16 shows a cross section of a variant of the feed additive particle of FIG. 15, where the particle has pores.

FIG. 17 depicts how to read the subsequent figures which include the raw data represented in Tables 29 and 30. The subsequent figures are 17A to 17P.

In the drawings, embodiments are illustrated by way of example. It is to be expressly understood that the description and drawings are only for the purpose of illustrating certain embodiments and are an aid for understanding. The scope of the claims should not be limited by the embodiments set forth in the present disclosure, but should be given the broadest interpretation consistent with the description as a whole.

### DETAILED DESCRIPTION OF EMBODIMENTS

The present disclosure broadly relates to an animal feed pellet including E. coli bacteria in an amount sufficient to afford a beneficial effect to an animal having ingested the animal feed.

In one practical implementation, the animal feed is an animal feed pellet, which includes viable E. coli bacteria. In the present disclosure, the term viable refers to the concept that while bacteria in the animal feed can be considered as being in a non-active (dormant) state, these bacteria can be restored to an active state upon exposing the bacteria to certain conditions, for example, sufficient temperature, moisture and/or oxygen.

Advantageously, administration of such animal feed pellet may require minimum handling by animal producers and/or may not need dose preparation. Further, long term administration through other means (e.g., drinking water) may have a significant impact in the survival of the strain compared to the herein described feed.

Escherichia coli (E. coli) are non-spore-forming bacteria, and as such, are less resistant to harsh conditions than spore-forming bacteria. Further, the current industry practice in pelleting feed in terms of pressure, temperature and moisture conditions aim to control pathogens such as E. coli and salmonella to minimum levels to reduce contamination risks. The current application surprisingly relates to an animal feed pellet which includes E. coli in high amounts and is, nevertheless, proper for animal consumption. In other words, the animal feed pellet described in the present disclosure includes non-pathogenic E. coli in an amount sufficient to provide a desired benefit to the animal ingesting the feed and, yet, the animal feed is still proper for consumption in having controlled (minimized) levels of pathogenic E. coli.

The present disclosure is surprising at least in that while the pathogen-controlling conditions discussed previously are still implemented when making the pelleted feed in the present disclosure, thus controlling pathogens, viability of the non-pathogenic E. coli is sufficiently maintained by embedding the desired E. coli strain into a suitable feed additive before proceeding with the pelleting step.

The present inventor has surprisingly and unexpectedly observed that an animal feed pellet including the viable non-pathogenic E. coli embedded in a feed additive as described herein was capable of preserving viability and functionality of sufficient bacteria CFU over an extended given period of time of 26 weeks at 25° C., for a commercial use thereof.

Embedding E. coli in Feed Additive

Practical implementations of incorporating bacteria in feed additives, albeit probiotics, have been proposed in the art.

For example, WO 2011/094469 describes compositions which include a mixture of sodium alginate, oligosaccharides (inulin, maltodextrins, dextrans, etc.) in a weight ratio of 1:1-10 of sodium alginate/oligosaccharide, a disaccharide and a hydrolyzed protein. WO 2013/142792 describes compositions which include an oligosaccharide, a disaccharide and a polysaccharide, and a protein component including hydrolyzed animal or plant proteins. Each of these documents describes the same procedure for obtaining probiotic encapsulated in feed additive in dry form:
In a first step, forming frozen beads containing a mixture of the compositions and a probiotic (where the probiotic is either from a frozen liquid culture or from a commercial powder form of the probiotic bacteria). The frozen beads are obtained by immersing droplets of the mixture into liquid nitrogen, and storing the resulting beads at −80° C.
In a second step, the frozen beads are dried under vacuum until the beads reach a water activity of less than 0.3.

The encapsulating procedure described in these documents, thus, combines the harsh conditions of freezing in liquid nitrogen and of subsequent drying. Such harsh conditions have a toll on the viability of the bacteria as reflected with the CFU log loss obtained of 0.73-0.90 despite the presence of the compositions, which is taught in these documents as allegedly being a dry stabilizing composition (see, e.g., FIG. 7 in WO 2011/094469 and FIG. 14 in WO 2013/142792). The process and composition described in these documents is, therefore, not optimized for industrial setting when employing liquid bacteria cultures as starting materials, where CFU log loss can result in less than ideal economics.

Other practical preservation and storage conditions for bacteria, albeit probiotics, have also been previously suggested.

Freeze-drying (also named lyophilisation) is often used for preservation and storage of bacteria because of the low temperature exposure during drying (Rhodes, Exploitation of microorganisms ed. Jones, D G, 1993, p. 411-439, London: Chapman & Hall). However, it has the undesirable characteristics of significantly reducing viability as well as being time and energy-intensive. Protective agents have been proposed, but the protection afforded by a given additive during freeze-drying varies with the species of micro-organism (Font de Valdez et al., Cryobiology, 1983, 20: 560-566).

Air drying such as with desiccation has also been used for preservation and storage of bacteria. While vacuum drying is a similar process as freeze-drying, it takes place at 0°-40° C. for 30 min to a few hours. The advantages of this process are that the product is not frozen, so the energy consumption and the related economic impact are reduced. From the product point of view, the freezing damage is avoided. However, desiccation at low or ambient temperature is slow, requires extra precautions to avoid contamination, and often yields unsatisfactory viability (Lievense et al., Adv Biochem Eng Biotechnol., 1994, 51:71-89).

Encapsulating bacteria in hydrocolloid-forming polysaccharide matrix, such as Calcium-alginate (Ca-alginate) beads, has also been used for preservation and storage of bacteria in a broad and increasing range of different applications (Islam et al., J. Microbiol. Biotechnol., 2010, 20:1367-1377). To maintain the bacteria in a metabolically and physiologically competent state and thus obtain the desired benefit, it has been suggested to add to such matrices a suitable preservative formulation. Preservative formulations typically contain active ingredients in a suitable carrier and additives that aid in the stabilization and protection of the microbial cells during storage, transport and at the target zone.

The development of novel formulations is, however, a challenging task and not all formulation are effective for a given bacteria (Youg et al., Biotechnol Bioeng., 2006 Sep. 5; 95(1):76-83). Further, a particular problem results for encapsulated bacteria in that in order to ensure an appropriate shelf-life of the product, one has to carefully minimize exposure of the bacteria to humidity during preparation, storage and/or transport.

The herein described composition of matter and methods of making same provide a feed additive which helps protect the viable E. coli bacteria (in particular when made from a liquid culture) against (1) the drying conditions performed when making the feed additive and (2) the harsh temperature, moisture and pressure conditions used when pelleting the animal feed. Indeed, the results obtained in the present disclosure show that an unexpected and surprising CFU average log loss, subsequent to the drying step, often close to 0.30. For example, of less than 0.70, or of less than 0.60, or of less than 0.50, or of less than 0.40, or of less than 0.30, or of less than 0.25, or of less than 0.20, or of less than 0.15, or of less than 0.10.

For example, the viable E. coli can sustain fold reduction in the particles during the embedding into the feed additive procedure of at least 0.4, or at least 0.5, or at least 0.6, or at least 0.7 without significant CFU loss, as described later in this text.

Advantageously, the herein described method of making the feed additive can be implemented in an industrial setting without at least some of the disadvantages of previously known procedures. For example, in an industrial setting it is often the case that large production batches are produced in a more or less continuous fashion, which typically submits the bacteria to high temperature and/or moisture for extended periods of time, e.g., from hours to days. The herein described procedure sufficiently protects the non-pathogenic E. coli from such conditions so as to afford sufficient survival (i.e., sufficient CFU) for the proposed desired result, despite the extended period of time where the E. coli is not in an ideal temperature/moisture setting for long term survival.

In a practical implementation, the method for preparing an animal feed pellet may include providing ingredients for making the feed pellet and a feed additive, where the feed additive includes the viable non-pathogenic E. coli. The method then further includes pelleting the ingredients and the feed additive to obtain the animal feed pellet. Pelleting procedures are known in the art and will, thus, not be further discussed here.

In one embodiment, the method may further include providing feed additive in the form of particles. Advantageously, the particles may have a heterogeneous population of mean particle sizes. For example, the particles may include a first population of particles having a first mean diameter size and a second population of particles having a second mean diameter size. Procedures for obtaining particles having a given mean diameter size, such as sieving or filtering, are known in the art and will not be further discussed here. In a particular embodiment, the feed additive may include an amount of the first population and an amount of the second population which are selected so as to obtain a ratio of first to second populations which is >1. In one non limiting embodiment, the first particle mean size is of at least 250 micron, or at least 500 micron, or at least 1 mm.

In a non-limiting embodiment, the feed additive can be cut into desired shapes and sizes, or crushed and milled into a free flowing powder. The feed additive can be further processed using wet or dry agglomeration, granulation, tableting, compaction, pelletization or any other kind of delivery process readily available to the person of skill. Processes for crushing, milling, grinding or pulverizing are well known in the art. For example, a hammer mill, an air mill, an impact mill, a jet mill, a pin mill, a Wiley mill, or similar milling device can be used.

### Feed Additive Characteristics

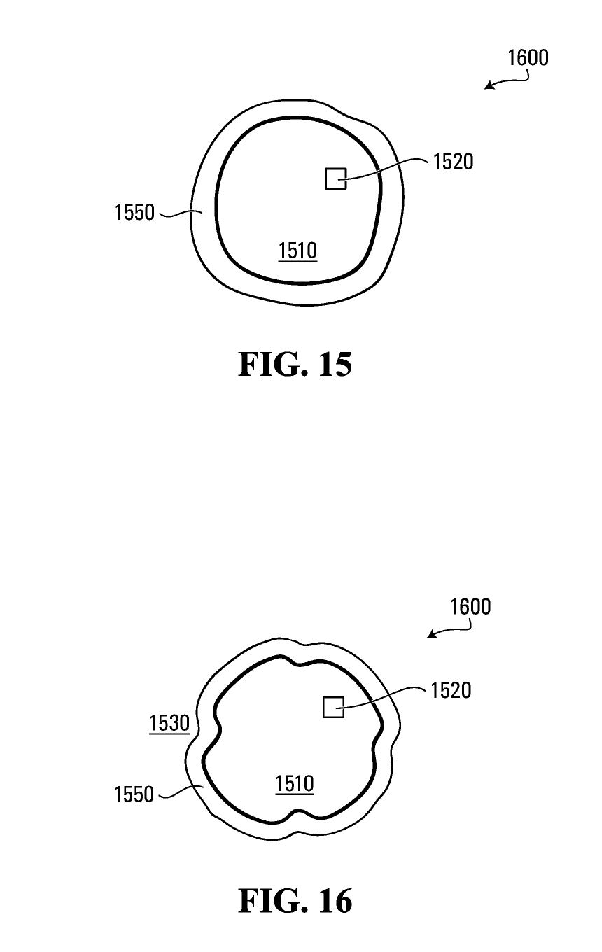

FIG. 15 shows a cross section view of a feed additive particle 1600 in accordance with an embodiment of the present disclosure.

In the specific embodiment illustrated in FIG. 15, the particle 1600 includes a matrix 1510 having an E. coli 1520 embedded therein. The matrix 1510 can include a coating 1550 that covers at least a portion of the surface of the particle 1600. The coating 1550 is shown as having variations in thickness that may be inherent in some of the coating application processes.

With reference to FIG. 16, the matrix 1510 may include pores. In some embodiments, the particle may include pores that may be inherent to the material used for making the matrix. In other embodiments, the particles may include pores that are made by injecting air/gas in the mixture when making the particles. In other embodiments, the particles may include pores due to a combination of both concepts. Advantageously, the presence of pores may require less material for making the matrix due to the presence of void areas 1530 and/or may increase penetration of ingredients into the particles. As shown in FIG. 16, the coating 1550 may cover at least a portion of the surface of the surface of the particles defining the pores.

For some specific embodiments, the coating 1550 may cover more or less the entire surface of the feed additive particle 1600.

Advantageously, embedding the viable E. coli in the matrix, as described herein, can minimize exposure of the bacteria to ambient moisture, oxygen and/or temperature during the animal feed or the feed additive manufacturing procedures. For example, when producing animal feed pellets using an extruder, one typically exposes the animal feed ingredients to relatively high pressure, temperature and moisture conditions during extrusion, thereby leading to CFU loss when the bacteria is not protected in some manner. Additional protection is not necessarily a requirement when the bacteria are spore-forming bacteria, such as when using typical probiotics. In this case, however, the E. coli are generally sensitive to such harsh extrusion conditions and accordingly, embedding the bacteria in the herein described matrix may help in minimizing damage resulting from exposure to such harsh extruding conditions, thereby minimizing CFU loss.

Additionally or alternatively, embedding the bacteria in a matrix as described herein may help with bacterial stability during storage/handling. Indeed, exposure of the bacteria to ambient moisture, oxygen and/or temperature during storage/handling may cause the bacteria to switch from a non-active state (dormant) to an active state. Unless this exposure is controlled, such switching may result in unquantifiable and uncontrolled growth of the bacteria, which will affect the effective dosage which is delivered to an animal ingesting the feed animal that contains such bacteria, thereby affecting the consistency of expected results.

Additionally or alternatively, embedding the bacteria in a matrix as described herein may afford a controlled release of the bacteria from the animal feed following ingestion by the animal, thereby enabling a time-release or location-release bacterial delivery system.

For example, when the matrix includes materials that are mostly non-digestible by intestinal or gastric juices, the bacteria are protected from gastric destruction while being shielded by the matrix. In a non-limiting embodiment, the matrix can thus be adapted for releasing the bacteria upon reaching a suitable environment, for example in the intestines. In such embodiment, the matrix can include a compound such as high amylose starch and/or pectin which is mostly non-digestible by intestinal or gastric juices while being readily digestible by the gut microflora at which time the delivered live bacteria are then released in their intact form. Selecting a suitable concentration of a matrix component, therefore, may afford a controlled release of the bacteria from the animal feed following ingestion by the animal. In other words, this embodiment may provide a time-release or location-release of bacteria.

In another example, the matrix can be in the form of particles where the size of the particles can afford a controlled time-release or location-release of bacteria from the animal feed following ingestion by the animal. In other words, a particle of larger size may be entirely degraded after a longer time in given gastric juices and/or intestine environment relative to a particle of smaller size. The particle size of the matrix can thus be selected/customized so as to afford a controlled time-release or location-release of bacteria from the animal feed. In a non-limiting embodiment, the particles may have a mean diameter size which is less than the feed pellet within which it is included, for example, less than 2 mm, or less than 1 mm, and the like. In other embodiments, the matrix may be in the form of particles having at least a first population of particles having a first particle mean size and a second population of particles having a second particle mean size wherein the size ratio between the first and the second particles mean sizes is greater than 1. In one non limiting embodiment, the first particle mean size is of at least 250 micron, or at least 500 micron, or at least 1 mm.

Advantageously, the herein described animal feed pellet may include heterogeneous feed additive particle mean diameter sizes, such that the feed additive is capable of releasing the bacteria in a controlled and pre-determined manner. For example, the pellets may include heterogeneous diameter feed additive particle sizes such that each feed additive particle is effectively digested at a given time and/or a given intestine location, which depends on the actual mean diameter size of the particles. For example, the pelleted animal feed may include feed additive particle of various sizes, such as 0.1 mm, 0.5 mm, 1 mm, 2 mm and the like, so long as the particles are smaller than the animal feed pellets. The person of skill will readily understand that any combination of suitable feed additive particle sizes is meant to fall within the scope of the present disclosure.

Additionally or alternatively, incorporating the feed additive with the animal feed, where the feed additive is in the form of particles having a heterogeneous particle size distribution, makes it possible to modulate the amount of bacteria reaching the intestines and therefore control the release of bacteria in the animal. Upon ingestion of the pelleted feed comprising the feed additive described herein, the pelleted feed transits through the stomach where the pellets are at least partially degraded and can, thereby, at least partially release the feed additive. The feed additive advantageously may include elements that protect the bacteria from the acid pH of the stomach. This may be particularly advantageous in animals which may become desensitized to the bacteria in the feed additive, such that it may be advisable to limit “pulse-type” delivery of the bacteria (i.e., where an entirety of the bacteria is released over a short period of time).

In a practical implementation, the feed additive described herein may be used to customize the amount of bacteria that is incorporated into a given animal feed.

For example, a feed additive having a given controlled concentration of viable non-pathogenic bacteria can be used in the making of an animal feed pellet for a particular animal. For example, an animal feed pellet intended for poultry will not necessarily require the same amount of viable non-pathogenic bacteria to obtain a beneficial effect as a comparative animal feed pellet intended for swine or cattle. Rather than having to use different proportions of feed additive when making swine feed as opposed to poultry feed, if desired, the person of skill can instead use similar proportions but with a feed additive comprising a given controlled concentration of the non-pathogenic bacteria specific for swine.

In other words, the feed additive may be manufactured according to the intended animal specification and include a given CFU/g amount suitable for the intended animal, i.e., according to a “swine grade”, “cattle grade”, “poultry grade”, and the like.

Alternatively, the same “grade” may be used as starting material for making animal feed pellet, but instead, the animal specification customization may be made at the feed pellet manufacturing level by using different proportions of feed additive when making swine feed as opposed to poultry feed.

Additionally or alternatively, the feed additive having a given controlled concentration of the non-pathogenic bacteria can be used in the making of an animal feed pellet for a particular phase of the growth curve of a particular animal. For example, an animal feed pellet for swine may have a controlled amount of the viable bacteria which is different at the post-weaning stage compared to the subsequent plurality of fattening stages.

For example, in certain non-limiting implementations, the animal feed pellet may include a number of CFU/g of viable bacteria of at least 10⁴, or at least 10⁵, or at least 10⁶, or at least 10′, or at least 10⁸, or at least 10⁹, or at least 10¹¹. For example, the animal feed pellet may include from 1×10⁵ to 1×10¹¹ CFU/g, or any value therein. Such different number of CFU/g can be obtained, for example, by incorporating increasing amounts of a feed additive including a controlled amount of viable bacteria or by incorporating different grades of feed additive during the manufacturing of the animal feed pellet. The person of skill will readily understand that in this context, the grades of feed additive may correspond to a feed additive having different controlled amounts of viable bacteria. Such customization of the amount of bacteria in a given animal feed can be made at any location along the chain supply, for example at the particle bead producing site, at the animal feed producing site, at the end-user site, etc.

Accordingly, the reader will also readily understand that the feed additive includes a suitable amount (CFU/g) of the E. coli strain in order to achieve the previously described CFU/g in the animal feed pellet. For example, the feed additive may include at least 1×10⁶ CFU/g, or at least 1×10′, or at least 1×10⁸, or at least 1×10⁹, or at least 1×10¹⁰, or at least 1×10¹¹, and the like.

The herein described customization of the amount of bacteria in a given animal feed can be useful in the context of animals reared for meat production, e.g., in the swine industry, farms typically feed the animals using a feed program with different feed phases (e.g., 2 to 4 phases), where the first feed (i.e., first weaning feed) can be given for about a period of one week to two weeks. In such cases, having such customization of the amount of bacteria in a given animal feed can be useful so as to obtain different levels of bacteria in the animal feed for different feed phases. For example, in the case where the E. coli included in the feed additive addresses particular enteric stresses for pigs, it may be industrially useful to customize the animal feed to include particular levels of bacteria therein for the first weaning and the first fattening feed phases, since these two phases represent two windows of enteric stresses for pigs.

E. coli Bacteria

In a non-limiting embodiment, the herein described non-pathogenic Escherichia coli (E. coli) comprise any recombinant or wild E. coli strain, or any mixtures thereof.

In a non-limiting embodiment, the E. coli strain is the strain deposited at the International Depository Authority of Canada (IDAC) on Jan. 21, 2005 under accession number IDAC 210105-01 described in U.S. Pat. No. 7,981,411 (incorporated herein by reference in its entirety), or the strain deposited at the International Depositary Authority of Canada (IDAC) on Jun. 20, 2013 and attributed accession number 200613-01 described in U.S. Pat. No. 9,453,195 (incorporated herein by reference in its entirety), or a combination thereof.

The IDAC is a patent depository for microorganisms that has been made possible by Canada's accession to the Budapest Treaty on the International Recognition of the Deposit of Micro-Organisms for the Purposes of Patent Procedure (the Budapest Treaty) on Sep. 21, 1996. In addition, amendments to the Canadian Patent Act and Patent Rules to ensure conformity with the Budapest Treaty came into effect on Oct. 1, 1996. The physical address of the IDAC is: 1015 Arlington Street, Winnipeg, Canada, R3E 3R2.

The person of skill will readily recognize that the E. coli may be, prior to being embedded in the matrix, in a dried, fresh or frozen form. Such form may be obtained directly from the culture form (i.e., strain in presence of culture media) or may be obtained after one or more processing steps such as to remove or substitute one or more elements from the culture media with another one or more elements, e.g., suitable for cryopreservation or for any another subsequent processing step.

Examples of one or more elements suitable for cryopreservation may meet at least one of the following features: be highly water soluble, penetrate inside the cell, have a low toxicity, be non-reactive, and not precipitate at high concentrations. For example, one or more elements suitable for cryopreservation may include for example but without being limited to, glycerol, sucrose, trehalose, bovine serum albumin (BSA).

### Matrix

The matrix comprises a hydrocolloid-forming polysaccharide. Several hydrocolloid-forming polysaccharides are suitable for use as described herein, alone or in any combination thereof.

High amylose starch is an example of suitable hydrocolloid-forming polysaccharide capable of forming firm gel after hydrating the starch granules in boiling water, dispersing the granules with the aid of high shear mixer and then cooling the solution to about 0-10° C. The firmness and strength of the gel depend on the concentration of the starch in the solution, with a maximal workable concentration of up to 10% w/v.

Pectin is another example of suitable hydrocolloid-forming polysaccharide that performs very similar to high amylose starch. Pectin has an additional advantage since the strength of the pectin gel matrix can be further increased by the addition of divalent cations such as Ca²⁺ that forms bridges between carboxyl groups of the sugar polymers.

Alginate is another suitable example of suitable hydrocolloid-forming polysaccharide that can form a firm gel matrix by cross-linking with divalent cations. The alginate can be hardened into a firm gel matrix by internally cross-linking the alginate first polysaccharides with a dication, e.g. Ca²⁺, for example by extruding the alginate in the form of thin threads, strings, or substantially spherical beads into a Ca²⁺ bath. The alginate hardens upon interaction with Ca²⁺. Alternative methods of preparation of the matrix known in the art include spray atomization of the mixture into a bath containing Ca²⁺, emulsion-based technique as well as fluid-bed agglomeration and coating.

In a non-limiting embodiment, the hydrocolloid-forming polysaccharide is present in the matrix in percent by weight of total dry matter at a value of from 0.1% to 20%. In a non-limiting embodiment, the hydrocolloid-forming polysaccharide is present in the matrix in percent by weight of total dry matter at a value of from 0.1% to 19%, or from 0.1% to 18%, or from 0.1% to 17%, or from 0.1% to 16%, or from 0.1% to 15%, or from 0.1% to 14%, or from 0.1% to 13%, or from 0.1% to 12%, or from 1% to 12%, including any value therein.

In one embodiment, the polysaccharide is a first polysaccharide and the matrix further comprises a second polysaccharide which is different from the first polysaccharide. Optionally, the matrix may include a disaccharide.

Alternatively or additionally, the matrix may include a coating disposed on at least a portion of the surface of the matrix. The coating may include the second polysaccharide which is different from the first polysaccharide. Optionally, the coating may include the disaccharide.

In a non-limiting embodiment, the disaccharide and the second polysaccharide are present in the coating and/or in the matrix, in a ratio disaccharide/second polysaccharide (wt. %/wt. %) of from 1:10 to 10:1. In another non-limiting embodiment, this ratio is of 9:1, 9:2, 9:3, 9:4, 9:5, 9:6, 9:7, 9:8, 8:1, 8:2, 8:3, 8:4, 8:5, 8:6, 8:7, 7:1, 7:2, 7:3, 7:4, 7:5, 7:6, 6:1, 6:2, 6:3, 6:4, 6:5, 5:1, 5:2, 5:3, 5:4, 4:1, 4:2, 4:3, 3:1, 3:2, 2:1, 1:1, 1:2, 1:3, 1:4, 1:5, 1:6, 1:7, 1:8, 1:9, 2:3, 2:4, 2:5, 2:6, 2:7, 2:8, 2:9, 3:4, 3:5, 3:6, 3:7, 3:8, 3:9, 4:5, 4:6, 4:7, 4:8, 4:9, 5:6, 5:7, 5:8, 5:9, 6:7, 6:8, 6:9, 7:8, 7:9, or 8:9, including any ratio value in between.

In another non-limiting embodiment, the ratio of disaccharide/second polysaccharide (wt. %/wt. %) is of less than 10, or more preferably of less than 5. In a non-limiting embodiment, the ratio of disaccharide/second polysaccharide (wt. %/wt. %) is of about 1.

In a non-limiting embodiment, the disaccharide is present in the coating and/or in the matrix (in percent by weight of total dry matter) at a value of from 0.1% to 90%, or from 0.1% to 75%, or from 0.1% to 50%, or from 0.1% to 35%, or from 0.1% to 20%, or from 0.1% to 15%, or from 0.1% to 10%, including any value therein.

In a non-limiting embodiment, the disaccharide includes sucrose.

In a non-limiting embodiment, the disaccharide includes trehalose.

In a non-limiting embodiment, the disaccharide includes sucrose and trehalose.

In a non-limiting embodiment, the second polysaccharide includes maltodextrin.

In a non-limiting embodiment, the second polysaccharide includes dextran.

In a non-limiting embodiment, the second polysaccharide includes maltodextrin and dextran.

In a non-limiting embodiment, the dextran has a molecular weight between 20 and 70 kDa.

In a non-limiting embodiment, the feed additive (i.e., the matrix and/or the coating) further includes a salt of an amino acid.

In a non-limiting embodiment, the salt of the amino acid includes a salt of L-glutamic acid.

In a non-limiting embodiment, the salt is a sodium salt of L-glutamic acid.

The herein described matrix, upon exiting the herein described drying steps, has a water activity (“a_{w}”) which is a_{w}≤0.3, for example 0.04≤a_{w}≤0.3, 0.04≤a_{w}≤2.5, 0.04≤a_{w}≤2.0, 0.04≤a_{w}≤1.5, and the like. “Water activity” or “a_{w}” in the context of the present disclosure, refers to the availability of water and represents the energy status of the water in a system. It is generally defined as the vapor pressure of water above a sample divided by that of pure water at the same temperature. Water activity may be measured according to materials and procedures known in the art, for example, using an Aqualab Water Activity Meter 4TE (Decagon Devices, Inc., U.S.A.). Drying may include steps such as spray drying, fluidized bed drying, lyophilization, vacuum drying, and the like. Non-limiting practical implementations of a drying step are further described later in this text.

### Animal Feed Pellet Cover Layer

In another practical implementation, the animal feed pellet may further include a layer which covers at least a portion of the animal feed pellet surface, where the layer includes the feed additive, to form a coated animal feed pellet. The coating of the animal feed pellet may be performed according to methods known in the art such as spray drying, spray cooling, spray atomization, fluid bed agglomeration and emulsion-based techniques. Complete dispersion of the coating onto the uncoated animal feed pellet may be achieved by subjecting the uncoated animal feed pellet to a tumbling action.

In some embodiments, the presence of an additional source of the E. coli in the pellet (i.e., a first source in the external layer, and a second source which is incorporated into the pellet) may afford a time-release or location-specific delivery of the E. coli. Indeed, the external layer may be formulated with ingredients that dissolve at a given rate or in a given location along the animal gastrointestinal tract, which can be different as the rate of delivery of the E. coli which is incorporated into the animal feed.

In some embodiments, the coating of the animal feed pellet may further enhance the protection against moisture and spoilage and increase the shelf-life of the animal feed pellet. The coating of the animal feed pellet may further enhance the protection against contaminants.

In other embodiments, the coating of the animal feed pellet may improve the palatability of the animal feed pellet which further reduces the need to add palatability enhancers to the pellet. The coating of the animal feed pellet may also mask strong odors and flavors to further enhance the ingestion of the coated animal feed pellet by the animals.

### Packaging

In one practical implementation, the present disclosure relates to a packaging having a moisture-controlling barrier which is sufficient to control exposure of the contents therein to ambient moisture. In other words, the packaging may control exposure of the viable non-pathogenic bacteria of the disclosure (i.e., in the feed additive and/or in the feed pellet) to ambient moisture. An advantageous effect of having the moisture-controlling barrier is that the bacteria contained in the contents may substantially remain in a non-active state, thereby, substantially increasing the useful shelf life of the feed additive and/or the feed pellet.

In a practical implementation, the packaging may further include separate compartments configured for storing feed additive incorporated into feed pellets in at least one compartment and moisture controlling elements in at least another compartment.

In a non-limiting embodiment, the packaging may include an internal liner comprising polyethylene, polyurethane or any other suitable feed-compatible polymer. The lining may be a single layer or a multilayer material. Without wishing to be bound by any theory, it is believed that the lining may provide protection at least against leaks, moisture, oxygen, contamination and ultraviolet (UV) irradiation and ensures a suitable shelf-life of the feed additive and/or the feed pellet.

In a practical implementation, the packaging may include a seal at an upper end through any appropriate sealing mechanism. The opening of the seal at the upper end can provide an outlet for dispensing feed additive and/or the feed pellet.

In another practical implementation, the packaging may include separate compartments configured for storing feed additive in at least one compartment and feed pellet ingredients in at least another compartment.

In a non-limiting embodiment, the at least one compartment for storing feed additive and the at least another compartment for storing feed pellet ingredients may be configured to prevent fluid communication in between, i.e., such that these are not interconnected. The lack of interconnection may prevent the premature intermixing of the feed pellet ingredients and the feed additive.

In a non-limiting embodiment, the at least one compartment for storing feed additive may be configured to store a quantity of feed additive (i.e. equivalent to a number of CFU of viable bacteria) suitable for addition to an entirety of the contents of the at least another compartment for storing feed pellet ingredients. According to this embodiment, the preparation of feed pellets with feed additive is simplified since the user is not required to compute an amount of feed additive to add to the pelleted feed. As discussed previously, the quantities of CFU in the feed additive may be customized according to different grades, i.e., that may vary according to the particular animal application. In such applications, instead of having to compute the amount of feed additive to add to the pelleted feed, the user may select to sue a particular “swine” packaging already having the suitable amounts of CFU in the feed additive so as to obtain a “swine” feed pellet. As a non-limiting example, a packaging with a quantity λ of feed additive may be suitable for the preparation of feed pellets for post-weaning piglets, while a packaging with a quantity β of feed additive may be suitable for the preparation of feed pellets for piglets in the fattening phase.

In other embodiments, the packaging may further comprise additional compartments configured to store different feed additives or various quantities of feed additives.

Advantageously, the packaging may be marked with a “use by” or “sell by” date to ensure a desired minimal amount of CFU (i.e., a desired CFU/g) on the “use by” or “sell by” date. Indeed, the person of skill is capable of extrapolating the useful amount of CFU which remains after a given time period, for example by taking into account the expected moisture/temperature/oxygen exposure of the feed additive after the given time period.

### System for Dispensing a Feed Additive

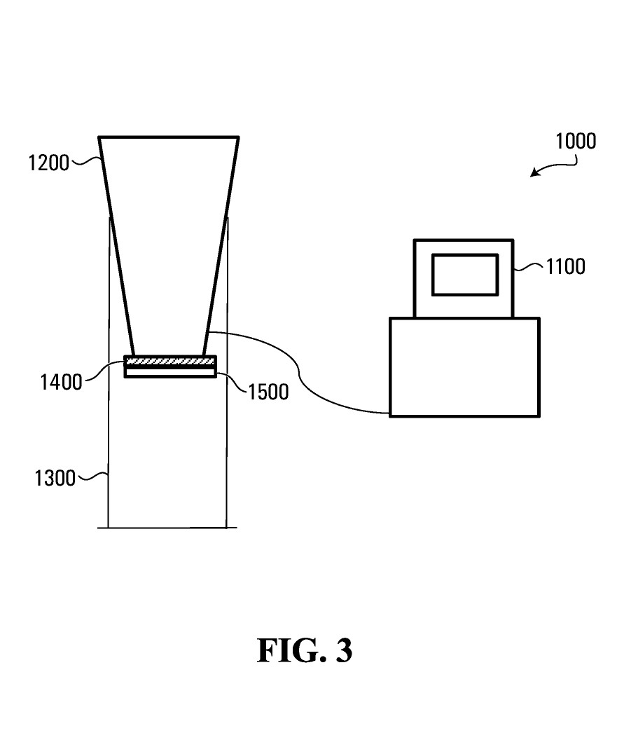

FIG. 3 illustrates a system 1000 for dispensing the herein described feed additive. The system 1000 includes several separate components including at least a remote control unit 1100, a hopper configured to store the feed additive 1200, a stand 1300, a sealing mechanism 1400 and a dispensing mechanism 1500.

In a non-limiting embodiment, the remote control unit 1100 comprises a computer and may be housed within a cabinet (not shown) which can be securely connected to the stand 1300 over a data network (not shown). In practical implementations, the data network may be any suitable data network including but not limited to public network (e.g., the Internet), a private network (e.g., a LAN or WAN), a wired network (e.g., Ethernet network), a wireless network (e.g., an 802.11 network or a Wi-Fi network), a cellular network (e.g., a Long Term Evolution (LTE) network), routers, hubs, switches, server computers, and/or any combinations thereof.

The hopper 1200 may be open at an upper end so as to be configured to receive the feed additive. The hopper 1200 may be connected at a lower end to the sealing mechanism 1400. The sealing mechanism 1400 may be movable between a closed position (as shown in FIG. 3) wherein an inner portion of the hopper 1200 is not in communication with the dispensing mechanism 1500 and an open position wherein the inner portion of the hopper 1200 is in communication with the dispensing mechanism 1500 (not shown).

In a non-limiting embodiment, the dispensing mechanism 1500 may comprise a removable mesh of a defined mesh size. In a preferred embodiment, the mesh size is selected such that only beads of feed additive of a specific diameter are dispensed through the dispensing mechanisms. As non-limiting examples, the mesh size may be selected such that only beads of up to 250 micron, up to 500 micron, up to 1 mm or up to 2 mm may be dispensed through the dispensing mechanism. Depending on the bead diameter distribution of the source feed additive, the dispensing mechanism may be used to dispense beads of a homogeneous or heterogeneous diameter.

In other embodiments, the dispensing mechanism 1500 may comprise a plurality of removable meshes of distinct mesh sizes layered on top of each other such that the dispensing mechanism may advantageously be used to dispense beads of feed additive of a homogeneous diameter using as a source a feed additive having a heterogeneous bead size distribution. That is, several feed additives having distinct bead diameters may be mixed and loaded in the hopper 1200 so as to result in a feed additive in the hopper 1200 having a heterogeneous bead size distribution. Using the appropriate sequence of removal of meshes, the system of the present invention may conveniently be used to dispense from an heterogeneous bead size distribution a first portion of feed additive having a first bead diameter and therefore a first CFU of viable non-pathogenic bacteria in an amount X and a second portion of feed additive having a second bead diameter and therefore a second CFU of viable non-pathogenic bacteria in an amount Y. Accordingly, the system 1000 may be used to obtain the different “grade” of feed additive/feed pellets discussed elsewhere in this text. Briefly, a certain amount of CFU can be selected and provided (i.e., customized) for a given application (e.g., animal species and/or growth phase) by selecting specific particle size amount ratios that are then dispensed for making the pellets.

In a non-limiting embodiment, the hopper 1200 is preferably made of stainless steel.

In a non-limiting embodiment, the hopper 1200 may further include within its inner portion a mixing mean (not shown) to prevent clogging at the lower end of the hopper 1200. In other embodiments, the feed additive may be dispensed with a liquid such as water to prevent the clogging of the system.

The person of skill will readily understand that other dispenser systems may be applicable without departing from the invention.

### EXAMPLES

In the following examples, three preservation solutions were tested along with preservation solution S1. The tests were performed in triplicates and one standard deviation was calculated according to the following formula:

$$SD = \sqrt{\frac{\sum {( x - \overline{x} )}^{2}}{n}}$$

with n: number of samples and mean of sample population.

In each of the following examples, bacterial viability was assessed by measuring the number of colony-forming units (CFU) according to protocols known in the art.

The preservation solutions used in the following examples are shown in Table 1.

TABLE 1

| | | | | Ratio second |
|---|---|---|---|---|
| | | | | polysaccharide/ |
| | second | | salt of | disaccharide/ |
| preservation | polysac- | Disac- | L-glutamic | salt of organic |
| solution | charide | charide | acid | acid |
| S0 | x ¹ | x | x | N/A ² |
| S1 | dextran 40 | sucrose | yes | 5:7:1 |
| S2 | dextran 40 | x | x | N/A |
| | (5 wt %) | | | |
| S3 | x | Sucrose | x | N/A |
| | | (7 wt %) | | |
| S4 | dextran 40 | trehalose | yes | 5:7:1 |
| S5 | dextran 20 | sucrose | yes | 5:7:1 |
| S6 | dextran 70 | sucrose | yes | 5:7:1 |
| S7 | maltodextrin | sucrose | yes | 5:7:1 |
| S8 | dextran 40 | sucrose | yes | 10:1:1 |
| S9 | dextran 40 | sucrose | yes | 1:10:1 |
| S10 | dextran 40 | sucrose | yes | 5:7:1 |
| S11 | x | sucrose | yes | 7:1 |
| S12 | dextran 70 | trehalose | yes | 5:7:1 |
| S13 | dextran 40 | sucrose | x | 5:7 |
| S14 | dextran 40 | sucrose | yes | 5:3:1 |
| S15 | dextran 40 | sucrose | yes | 5:5:1 |
| S16 | maltodextrin | trehalose | yes | 5:7:1 |
| S17 | maltodextrin | trehalose | yes | 10:1:1 |
| S18 | maltodextrin | trehalose | yes | 1:10:1 |
| S19 | dextran 40 | maltose | yes | 5:7:1 |

¹ x means absent
² N/A means not applicable

### 1. Example 1

This example describes the preparation of a feed additive in accordance with an embodiment of the present disclosure. In this example, bacteria are encapsulated in a matrix made of alginate-calcium. The alginate-calcium matrix is in the form of particles, which can have a heterogeneous or homogeneous mean diameter size depending on the application. Because the beads are made with liquid bacterial culture as starting material, the person of skill will understand that the final composition of the herein described dried E. coli beads may include components of the bacterial culture media.

a. E. coli Culture

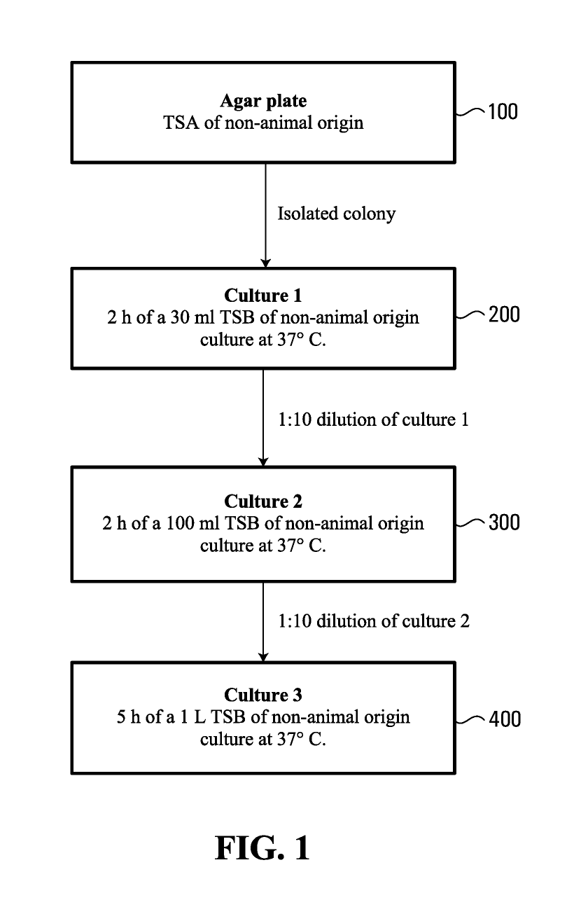

With reference to FIG. 1, an E. coli strain was cultivated in a first step 100 on Tryptic Soy Agar of non-animal origin. Six (6) isolated colonies were then used to cultivate the E. coli strain in a second step 200 for 2 hours at 37° C. and agitation at 200 rpm in 30 mL of Tryptic Soy Broth (TSB) of non-animal origin (for 1 L of TSB: 20 g of Soy Peptone A3 SC—(Organotechnie), 2.5 g anhydrous dextrose USP—(J.T. Baker), 5 g sodium chloride USP—(J.T. Baker), and 2.5 g dibasic potassium phosphate USP—(Fisher Chemical)).

The resulting Culture 1 was diluted by a factor of 10 in TSB and was then used to cultivate the E. coli strain in a third step 300 for 2 hours at 37° C. and agitation at 200 rpm in 100 mL of TSB of non-animal origin. The resulting Culture 2 was diluted by a factor of 10 in TSB and was then used to cultivate the E. coli strain in a fourth step 400 for 5 hours at 37° C. and agitation at 200 rpm in 1 L of TSB of non-animal origin. The resulting Culture 3 was then used to embed E. coli in matrix. Variations and refinements to the culture protocol herein described are possible and will become apparent to persons skilled in the art in light of the present teachings. For example, the non-pathogenic E. coli may also be cultivated in anaerobic conditions according to protocols known in the art (Son & Taylor, Curr. Protoc. Microbiol., 2012, 27:5A.4.1-5A.4.9). In preparing the beads of the subsequent examples, the non-pathogenic E. coli strain deposited at the International Depository Authority of Canada (IDAC) on Jan. 21, 2005 under accession number IDAC 210105-01 was used.

b. Matrix Preparation

Bacto™ peptone (1.5 g, BD, Mississauga, Canada) was mixed with 1.5 L of heated water to obtain a mixture. Alginate (30 g Grindsted®, DuPont™ Danisco®, Mississauga, Canada) was slowly added to the mixture while mixing with a magnetic bar at 360 rpm. Complete solubilisation of alginate was obtained in about 3 h to obtain a 2% alginate (m/v) solution. The solution including the magnetic bar was then autoclaved under standard conditions. Variations and refinements to the matrix preparation protocol herein described are possible and will become apparent to persons skilled in the art in light of the present teachings.

c. Embedding E. coli in Matrix

The following was added, in order and while mixing with the magnetic bar, to the autoclaved matrix solution (1.5 L) to obtain a slurry: 1 L of TSB of non-animal origin and, with reference to FIG. 1, 0.5 L of the resulting Culture 3 of E. coli.

The slurry (3 L) was extruded into a polymerization bath (300 mM CaCl₂, 0.1 wt./v. % Bacto™ tryptone, 0.1 wt./v. % Bacto™ peptone, and 0.05 wt./v. % g Bacto™ yeast extract in water) to form beads using a 9 exit syringe system adapted from the Thermo Scientific™ Reacti-Vap™ Evaporators. The bath was gently stirred while injecting the slurry. The matrix beads were allowed to cross-link for about 30 minutes, and the resulting hardened beads were then harvested. Variations and refinements to the embedding protocol herein described are possible and will become apparent to persons skilled in the art in light of the present teachings. The beads were then placed on a tray dryer in an air dryer at room temperature for about 24 h to obtain semi-dry beads and the semi-dry beads were then placed in a desiccator for about 64 h, in which dry and filtered air was blown to obtain dry beads.

The present inventor has surprisingly and unexpectedly observed that incubating embedded E. coli in preservation solutions with gentle stirring for about 20 mins prior to drying significantly reduces the loss of bacteria during the drying steps leading to the formation of the dried beads.

d. Drying and Testing of Embedded E. coli

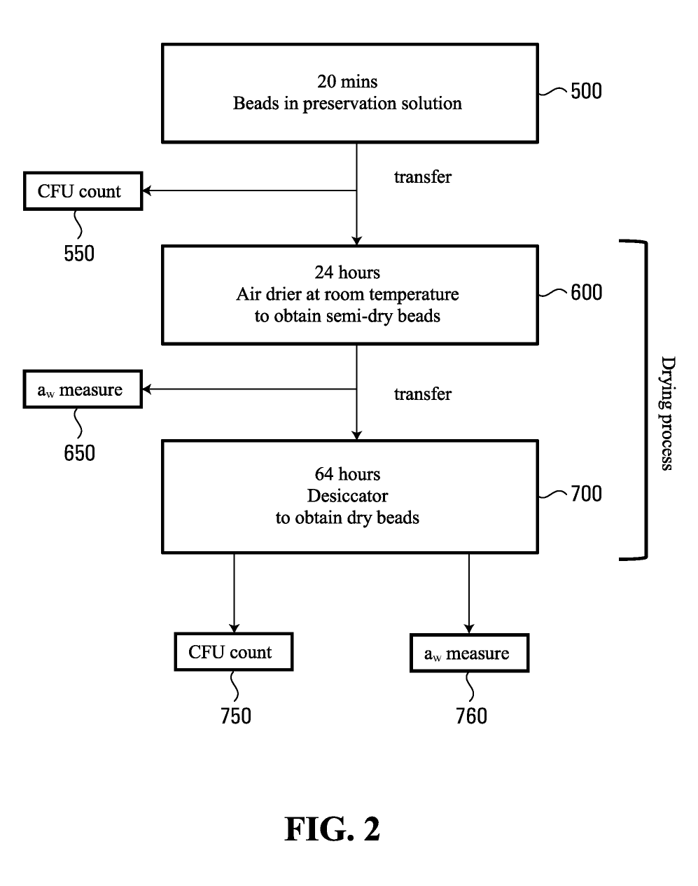

For each preservation solution, the drying and testing was performed at least in triplicates. With reference to FIG. 2, in a first step 500 the beads with embedded E. coli in the matrix were placed in a preservation solution S1, a preservation solution S2, a preservation solution S3 or a preservation solution S4 with gentle stirring for about 20 minutes. In each case, a determination of total CFU 550 was performed after soaking in the preservation solution. In a second step 600 the beads were then placed on a tray dryer in an air dryer at room temperature for about 24 h to obtain semi-dry beads. In each case, a measurement of water activity a_{w} 650 was performed on the semi-dry beads using an Aqualab Water Activity Meter 4TE (Decagon Devices, Inc., U.S.A.). In a third step 700 the semi-dry beads were then placed in a desiccator for about 64 h, in which dry and filtered air was blown. In accordance with an embodiment of the present disclosure, the drying process 800 includes at least two steps: a step 600 which includes placing beads in an air dryer for 24 hours at room temperature and to obtain semi-dry beads and a step 700 which includes placing the semi-dry beads in a desiccator for 64 hours to obtain dry beads. In each case, a determination of total CFU 750 and a measurement of water a_{w} 760 were performed on the dry beads. Dry beads having a water activity a_{w} of ≤0.3 were obtained.

In each case, and with reference to FIG. 2, the a_{w} fold reduction was calculated according to the following:

$${a}_{w} fold reduction = \frac{650 - 760}{650}$$

In each case, and with reference to FIG. 2, viability loss (CFU log loss) was calculated according to the following:

CFUloss=log₁₀(550)−log₁₀(750)

In each case, an average viability loss and normalized average viability loss relative to the results obtained with preservation solution S1 was calculated.

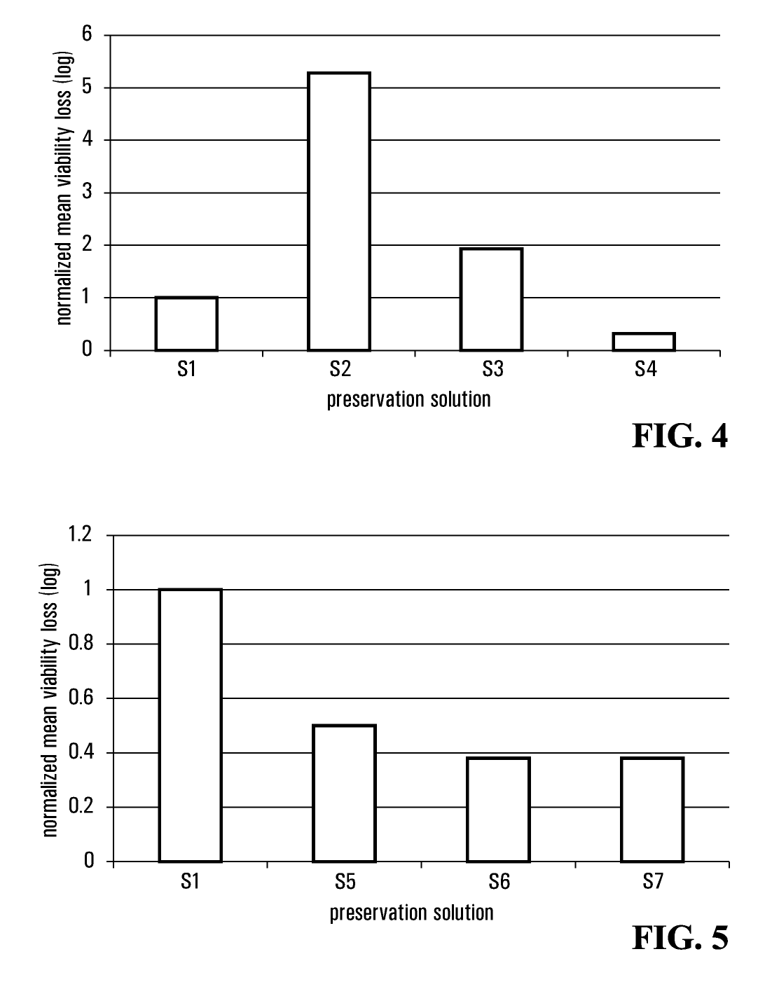

The results are shown in FIG. 4. Preservation solution S4 showed a normalized average viability loss of 0.32 while sustaining a water activity of 0.142±0.004.

A compilation of the results of Example 1 is set forth in Tables 2 and 3. These results demonstrate that the elements of preservation solutions S1 and S4 provided a significant effect to the viability of the E. coli embedded in the dried matrix and its resistance to the drying process 700.

TABLE 2

| | | step 750 | | |
|---|---|---|---|---|
| | | | average | Normalized |
| | step 550 | | CFU loss | CFU loss |
| Sample | average CFU | average CFU | (log₁₀) | (log₁₀) |
| S1 | 3 × 10¹¹ ± 9 × 10¹⁰ | 1.4 × 10¹¹ ± 4.3 × 10⁹ | 0.32 ± 0.14 | 1 |
| S2 | 2.3 × 10¹¹ ± 5.5 × 10¹⁰ | 5.4 × 10⁹ ± 2.7 × 10⁹ | 1.66 ± 0.3 | 5.18 |
| S3 | 2.6 × 10¹¹ ± 4.9 × 10¹⁰ | 7.4 × 10¹⁰ ± 4.3 × 10¹⁰ | 0.61 ± 0.32 | 1.90 |
| S4 | 3.1 × 10¹¹ ± 7 × 10¹⁰ | 2.5 × 10¹¹ ± 9.7 × 10¹⁰ | 0.11 ± 0.08 | 0.34 |

TABLE 3

step 760

| | step 650 | | a_{w} fold |
|---|---|---|---|
| Sample | average a_{w} | average a_{w} | reduction |
| S1 | 0.473 ± 0.020 | 0.165 ± 0.010 | 0.65 |
| S2 | 0.278 ± 0.021 | 0.054 ± 0.009 | 0.81 |
| S3 | 0.423 ± 0.022 | 0.150 ± 0.026 | 0.64 |
| S4 | 0.488 ± 0.022 | 0.142 ± 0.004 | 0.71 |

e. Incorporating Dried Embedded E. coli into an Animal Feed (“Pelleting”)

Protocol for incorporating dried matrix into an animal feed, for example in the form of a feed additive are known in the art. An illustrative example of doing such can be done, e.g., by incorporating 500 g to 1000 g of dried matrix beads into a ton of animal feed. If desired, the feed can also include inactivated yeast product in suitable amounts. For instance, the dried matrix beads comprising the embedded E. coli (i.e., feed additive) can be mixed in a homogenization tank with at least a portion of all the other ingredients. Preferably, the mixture is continuously mixed during the pelleting process. The mixed material is then pumped towards an extruder.

Steam is applied on the mixed material (i.e., steam-conditioning) either when it is about to enter the extruder or within a compartment located within the extruder (i.e., hence, the temperature of the mixture increases at this stage). Typical values of temperature may vary within the range of about 70 to about 90° C. Suitable pressure is applied on the mixture during its passage inside the extruder. Typical values of pressure may vary within the range of about 20 psig to about 80 psig. The formed pellets are then expelled out of the extruder into a cooling tank (rapid temperature drops to 30-40° C. followed by another cool down, to reach ambient temperature). Pelleted feed including the feed additive (matrix comprising embedded E. coli) can then be stored, for example in bags/containers, as further described below. Variations and refinements to the pelleting protocol herein described are possible and will become apparent to persons skilled in the art in light of the present teachings.

### 2. Example 2

For each preservation solution tested here, the drying and testing was performed at least in triplicates. With reference to FIG. 2, in a first step 500 beads prepared as in Example 1 were placed in a preservation solution S1, a preservation solution S5, a preservation solution S6 or a preservation solution S7 with gentle stirring for about 20 minutes. In each case, a determination of total CFU 550 was performed after soaking in the preservation solution. In a second step 600 the beads were then placed on a tray dryer in an air dryer at room temperature for about 24 h to obtain semi-dry beads. In each case, a measurement of water activity a_{w} 650 was performed on the semi-dry beads using an Aqualab Water Activity Meter 4TE (Decagon Devices, Inc., U.S.A.). In a third step 700 the semi-dry beads were then placed in a desiccator for about 64 h, in which dry and filtered air was blown. In accordance with an embodiment of the present disclosure, the drying process 800 includes at least two steps: a step 600 which includes placing beads in an air dryer for 24 hours at room temperature and to obtain semi-dry beads and a step 700 which includes placing the semi-dry beads in a desiccator for 64 hours to obtain dry beads. In each case, a determination of total CFU 750 and a measurement of water a_{w} 760 were performed on the dry beads. Dry beads having a water activity a_{w} of ≤0.3 were obtained.

In each case, and with reference to FIG. 2, the a_{w} fold reduction was calculated according to the following:

$${a}_{w} fold reduction = \frac{650 - 760}{650}$$

In each case, and with reference to FIG. 2, viability loss (CFU log loss) was calculated according to the following:

CFU loss=log₁₀(550)−log₁₀(750)

In each case, an average viability loss and normalized average viability loss relative to the results obtained with preservation solution S1 was calculated.

The results are shown in FIG. 5. Preservation solution S7 showed a normalized average viability loss of 0.38 while sustaining a water activity of 0.298±0.013.

A compilation of the results of Example 2 is set forth in Tables 4 and 5. These results demonstrate that the elements of preservation solution S7 provided a significant protective effect to the viability of the E. coli embedded in the dried matrix and its resistance to the drying process 700.

TABLE 4

| | | step 750 | | |
|---|---|---|---|---|
| | | | average | Normalized |
| | step 550 | | CFU loss | CFU loss |
| Sample | average CFU | average CFU | (log₁₀) | (log₁₀) |
| S1 | 3.3 × 10¹¹ ± 9.2 × 10¹⁰ | 1.8 × 10¹¹ ± 2.7 × 10¹⁰ | 0.26 ± 0.07 | 1 |
| S5 | 3.5 × 10¹¹ ± 7.7 × 10¹⁰ | 2.6 × 10¹¹ ± 6 × 10¹⁰ | 0.13 ± 0.17 | 0.5 |
| S6 | 3.1 × 10¹¹ ± 5.8 × 10¹⁰ | 2.8 × 10¹¹ ± 1.7 × 10¹¹ | 0.10 ± 0.29 | 0.38 |
| S7 | 3.4 × 10¹¹ ± 3.7 × 10¹⁰ | 2.7 × 10¹¹ ± 1 × 10¹⁰ | 0.10 ± 0.06 | 0.38 |

TABLE 5

step 760

| | step 650 | | a_{w} fold |
|---|---|---|---|
| Sample | average a_{w} | average a_{w} | reduction |
| S1 | 0.535 ± 0.020 | 0.230 ± 0.012 | 0.57 |
| S5 | 0.530 ± 0.049 | 0.249 ± 0.009 | 0.53 |
| S6 | 0.586 ± 0.143 | 0.260 ± 0.013 | 0.56 |
| S7 | 0.541 ± 0.045 | 0.298 ± 0.013 | 0.45 |

### 3. Example 3

For each preservation solution tested here, the drying and testing was performed at least in triplicates. With reference to FIG. 2, in a first step 500 beads prepared as in Example 1 were placed in either a preservation solution S1, a preservation solution S0, a preservation solution S8 or a preservation solution S9 with gentle stirring for about 20 minutes. In each case, a determination of total CFU 550 was performed after soaking in the preservation solution. In a second step 600 the beads were then placed on a tray dryer in an air dryer at room temperature for about 24 h to obtain semi-dry beads. In each case, a measurement of water activity a_{w} 650 was performed on the semi-dry beads using an Aqualab Water Activity Meter 4TE (Decagon Devices, Inc., U.S.A.). In a third step 700 the semi-dry beads were then placed in a desiccator for about 64 h, in which dry and filtered air was blown. In accordance with an embodiment of the present disclosure, the drying process 800 includes at least two steps: a step 600 which includes placing beads in an air dryer for 24 hours at room temperature and to obtain semi-dry beads and a step 700 which includes placing the semi-dry beads in a desiccator for 64 hours to obtain dry beads. In each case, a determination of total CFU 750 and a measurement of water a_{w} 760 were performed on the dry beads. Dry beads having a water activity a_{w} of ≤0.3 were obtained.

In each case, and with reference to FIG. 2, the a_{w} fold reduction was calculated according to the following:

$${a}_{w} fold reduction = \frac{650 - 760}{650}$$

In each case, and with reference to FIG. 2, viability loss (CFU log loss) was calculated according to the following:

CFU loss=log₁₀(550)−log₁₀(750)

In each case, an average viability loss and normalized average viability loss relative to the results obtained with preservation solution S1 was calculated.

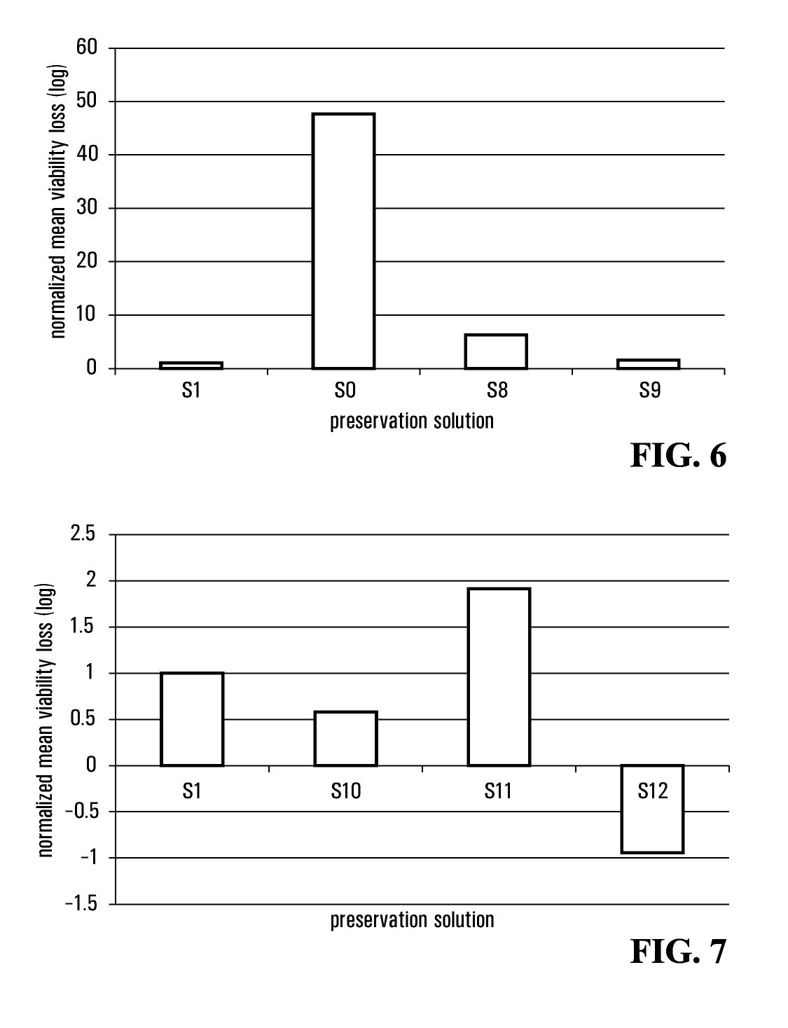

The results are shown in FIG. 6.

A compilation of the results of Example 3 is set forth in Tables 6 and 7.

TABLE 6

| | | step 750 | | |
|---|---|---|---|---|
| | | | average | Normalized |
| | step 550 | | CFU loss | CFU loss |
| Sample | average CFU | average CFU | (log₁₀) | (log₁₀) |
| S1 | 2.2 × 10¹¹ ± 2.9 × 10¹⁰ | 1.7 × 10¹¹ ± 9.3 × 10⁹ | 0.11 ± 0.05 | 1 |
| S0 | 1.9 × 10¹¹ ± 2 × 10¹⁰ | 1.5 × 10⁶ ± 1.5 × 10⁶ | 5.28 ± 0.53 | 47.7 |
| S8 | 2.8 × 10¹¹ ± 4.6 × 10¹⁰ | 5.9 × 10¹⁰ ± 2.3 × 10¹⁰ | 0.70 ± 0.15 | 6.28 |
| S9 | 2.4 × 10¹¹ ± 5.4 × 10¹⁰ | 1.5 × 10¹¹ ± 1.5 × 10¹⁰ | 0.18 ± 0.04 | 1.64 |

TABLE 7

step 760

| | step 650 | | a_{w} fold |
|---|---|---|---|
| Sample | average a_{w} | average a_{w} | reduction |
| S1 | 0.453 ± 0.010 | 0.241 ± 0.005 | 0.47 |
| S0 | 0.331 ± 0.022 | 0.037 ± 0.002 | 0.89 |
| S8 | 0.366 ± 0.010 | 0.062 ± 0.006 | 0.83 |
| S9 | 0.451 ± 0.010 | 0.275 ± 0.032 | 0.39 |

### 4. Example 4

For each preservation solution tested here, the drying and testing was performed at least in triplicates. With reference to FIG. 2, in a first step 500 beads prepared as in Example 1 were placed in either a preservation solution S1, a preservation solution S10, a preservation solution S11 or a preservation solution S12 with gentle stirring for about 20 minutes. In each case, a determination of total CFU 550 was performed after soaking in the preservation solution. In a second step 600 the beads were then placed on a tray dryer in an air dryer at room temperature for about 24 h to obtain semi-dry beads. In each case, a measurement of water activity a_{w} 650 was performed on the semi-dry beads using an Aqualab Water Activity Meter 4TE (Decagon Devices, Inc., U.S.A.). In a third step 700 the semi-dry beads were then placed in a desiccator for about 64 h, in which dry and filtered air was blown. In accordance with an embodiment of the present disclosure, the drying process 800 includes at least two steps: a step 600 which includes placing beads in an air dryer for 24 hours at room temperature and to obtain semi-dry beads and a step 700 which includes placing the semi-dry beads in a desiccator for 64 hours to obtain dry beads. In each case, a determination of total CFU 750 and a measurement of water a_{w} 760 were performed on the dry beads. Dry beads having a water activity a_{w} of ≤0.3 were obtained.

In each case, and with reference to FIG. 2, the a_{w} fold reduction was calculated according to the following:

$${a}_{w} fold reduction = \frac{650 - 760}{650}$$

In each case, and with reference to FIG. 2, viability loss (CFU log loss) was calculated according to the following:

CFU loss=log₁₀(550)−log₁₀(750)

In each case, an average viability loss and normalized average viability loss relative to the results obtained with preservation solution S1 was calculated.

The results are shown in FIG. 7. Preservation solution S7 showed a normalized average viability loss of 0.58.

A compilation of the results of Example 4 is set forth in Tables 8 and 9.

TABLE 8

| | | step 750 | | |
|---|---|---|---|---|
| | | | average | Normalized |
| | step 550 | | CFU loss | CFU loss |
| Sample | average CFU | average CFU | (log₁₀) | (log₁₀) |
| S1 | 3.7 × 10¹¹ ± 5.2 × 10¹⁰ | 2.8 × 10¹¹ ± 4.46 × 10¹⁰ | 0.12 ± 0.01 | 1 |
| S10 | 4 × 10¹¹ ± 1 × 10¹¹ | 3.3 × 10¹¹ ± 3.11 × 10¹⁰ | 0.07 ± 0.12 | 0.58 |
| S11 | 3.3 × 10¹¹ ± 3.9 × 10¹⁰ | 1.9 × 10¹¹ ± 1.77 × 10¹⁰ | 0.24 ± 0.03 | 1.91 |
| S12 | 4 × 10¹¹ ± 2.9 × 10¹⁰ | 5.3 × 10¹¹ ± 9.27 × 10¹⁰ | −0.12 ± 0.08 | −0.94 |

TABLE 9

step 760

| | step 650 | | a_{w} fold |
|---|---|---|---|
| Sample | average a_{w} | average a_{w} | reduction |
| S1 | 0.475 ± 0.023 | 0.123 ± 0.007 | 0.74 |
| S10 | 0.490 ± 0.026 | 0.135 ± 0.007 | 0.72 |
| S11 | 0.419 ± 0.016 | 0.201 ± 0.038 | 0.52 |
| S12 | 0.494 ± 0.026 | 0.165 ± 0.006 | 0.66 |

### 5. Example 5

For each preservation solution tested here, the drying and testing was performed at least in triplicates. With reference to FIG. 2, in a first step 500 beads prepared as in Example 1 were placed in either a preservation solution S1, a preservation solution S13, a preservation solution S14 or a preservation solution S15 with gentle stirring for about 20 minutes. In each case, a determination of total CFU 550 was performed after soaking in the preservation solution. In a second step 600 the beads were then placed on a tray dryer in an air dryer at room temperature for about 24 h to obtain semi-dry beads. In each case, a measurement of water activity a_{w} 650 was performed on the semi-dry beads using an Aqualab Water Activity Meter 4TE (Decagon Devices, Inc., U.S.A.). In a third step 700 the semi-dry beads were then placed in a desiccator for about 64 h, in which dry and filtered air was blown. In accordance with an embodiment of the present disclosure, the drying process 800 includes at least two steps: a step 600 which includes placing beads in an air dryer for 24 hours at room temperature and to obtain semi-dry beads and a step 700 which includes placing the semi-dry beads in a desiccator for 64 hours to obtain dry beads. In each case, a determination of total CFU 750 and a measurement of water a_{w} 760 were performed on the dry beads. Dry beads having a water activity a_{w} of ≤0.3 were obtained.

In each case, and with reference to FIG. 2, the a_{w} fold reduction was calculated according to the following:

$${a}_{w} fold reduction = \frac{650 - 760}{650}$$

In each case, and with reference to FIG. 2, viability loss (CFU log loss) was calculated according to the following:

CFU loss=log₁₀(550)−log₁₀(750)

In each case, an average viability loss and normalized average viability loss relative to the results obtained with preservation solution S1 was calculated.

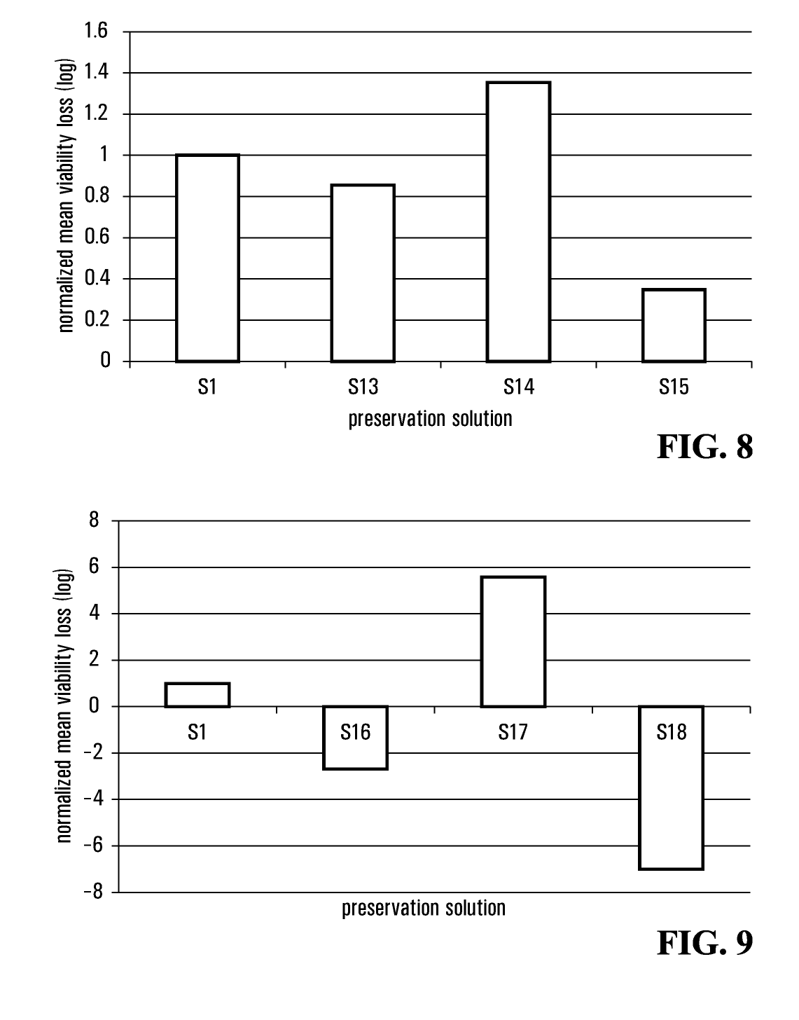

The results are shown in FIG. 8. Preservation solution S7 showed a normalized average viability loss of 0.35.

A compilation of the results of Example 5 is set forth in Tables 10 and 11.

TABLE 10

| | | step 750 | | |
|---|---|---|---|---|
| | | | average | Normalized |
| | step 550 | | CFU loss | CFU loss |
| Sample | average CFU | average CFU | (log₁₀) | (log₁₀) |
| S1 | 4.1 × 10¹¹ ± 3.8 × 10¹⁰ | 2.7 × 10¹¹ ± 3.44 × 10¹⁰ | 0.18 ± 0.10 | 1 |
| S13 | 3.8 × 10¹¹ ± 4.2 × 10¹⁰ | 2.6 × 10¹¹ ± 2.7 × 10¹⁰ | 0.15 ± 0.02 | 0.85 |
| S14 | 3.8 × 10¹¹ ± 6.1 × 10¹⁰ | 2.2 × 10¹¹ ± 3.55 × 10¹⁰ | 0.24 ± 0.08 | 1.35 |
| S15 | 4.4 × 10¹¹ ± 1.5 × 10¹⁰ | 3.8 × 10¹¹ ± 6.37 × 10¹⁰ | 0.06 ± 0.07 | 0.35 |

TABLE 11

step 760

| | step 650 | | a_{w} fold |
|---|---|---|---|
| Sample | average a_{w} | average a_{w} | reduction |
| S1 | 0.501 ± 0.041 | 0.177 ± 0.008 | 0.65 |
| S13 | 0.562 ± 0.101 | 0.247 ± 0.012 | 0.56 |
| S14 | 0.465 ± 0.031 | 0.133 ± 0.013 | 0.71 |
| S15 | 0.502 ± 0.037 | 0.198 ± 0.016 | 0.60 |

### 6. Example 6

For each preservation solution the drying and testing was performed at least in triplicates. With reference to FIG. 2, in a first step 500 beads prepared as in Example 1 were placed in either a preservation solution S1, a preservation solution S16, a preservation solution S17 or a preservation solution S18 with gentle stirring for about 20 minutes. In each case, a determination of total CFU 550 was performed after soaking in the preservation solution. In a second step 600 the beads were then placed on a tray dryer in an air dryer at room temperature for about 24 h to obtain semi-dry beads. In each case, a measurement of water activity a_{w} 650 was performed on the semi-dry beads using an Aqualab Water Activity Meter 4TE (Decagon Devices, Inc., U.S.A.). In a third step 700 the semi-dry beads were then placed in a desiccator for about 64 h, in which dry and filtered air was blown. In accordance with an embodiment of the present disclosure, the drying process 800 includes at least two steps: a step 600 which includes placing beads in an air dryer for 24 hours at room temperature and to obtain semi-dry beads and a step 700 which includes placing the semi-dry beads in a desiccator for 64 hours to obtain dry beads. In each case, a determination of total CFU 750 and a measurement of water a_{w} 760 were performed on the dry beads. Dry beads having a water activity a_{w} of ≤0.3 were obtained.

In each case, and with reference to FIG. 2, the a_{w} fold reduction was calculated according to the following:

$${a}_{w} fold reduction = \frac{650 - 760}{650}$$

In each case, and with reference to FIG. 2, viability loss (CFU log loss) was calculated according to the following:

CFU loss=log₁₀(550)−log₁₀(750)

In each case, an average viability loss and normalized average viability loss relative to the results obtained with preservation solution S1 was calculated.

The results are shown in FIG. 9.

A compilation of the results of Example 6 is set forth in Tables 12 and 13.

TABLE 12

| | | step 750 | | |
|---|---|---|---|---|
| | | | average | Normalized |
| | step 550 | | CFU loss | CFU loss |
| Sample | average CFU | average CFU | (log₁₀) | (log₁₀) |
| S1 | 3.3 × 10¹¹ ± 3.4 × 10¹⁰ | 3.1 × 10¹¹ ± 4.92 × 10¹⁰ | 0.03 ± 0.07 | 1 |
| S16 | 3.6 × 10¹¹ ± 4.1 × 10¹⁰ | 4.4 × 10¹¹ ± 9.91 × 10¹⁰ | −0.07 ± 0.11 | −2.68 |
| S17 | 3.2 × 10¹¹ ± 4.5 × 10¹⁰ | 2.3 × 10¹¹ ± 5.05 × 10¹⁰ | 0.15 ± 0.05 | 5.57 |
| S18 | 2.7 × 10¹¹ ± 3.9 × 10¹⁰ | 4.2 × 10¹¹ ± 4.76 × 10¹⁰ | −0.19 ± 0.06 | −6.98 |

TABLE 13

step 760

| | step 650 | | a_{w} fold |
|---|---|---|---|
| Sample | average a_{w} | average a_{w} | reduction |
| S1 | 0.734 ± 0.164 | 0.155 ± 0.003 | 0.79 |
| S16 | 0.575 ± 0.862 | 0.136 ± 0.015 | 0.76 |
| S17 | 0.742 ± 0.167 | 0.039 ± 0.004 | 0.95 |
| S18 | 0.536 ± 0.003 | 0.176 ± 0.029 | 0.67 |

### 7. Example 7

For each preservation solution tested here, the drying and testing was performed at least in triplicates. With reference to FIG. 2, in a first step 500 beads prepared as in Example 1 were placed in either a preservation solution S1 or a preservation solution S19 with gentle stirring for about 20 minutes. In each case, a determination of total CFU 550 was performed after soaking in the preservation solution. In a second step 600 the beads were then placed on a tray dryer in an air dryer at room temperature for about 24 h to obtain semi-dry beads. In each case, a measurement of water activity a_{w} 650 was performed on the semi-dry beads using an Aqualab Water Activity Meter 4TE (Decagon Devices, Inc., U.S.A.). In a third step 700 the semi-dry beads were then placed in a desiccator for about 64 h, in which dry and filtered air was blown. In accordance with an embodiment of the present disclosure, the drying process 800 includes at least two steps: a step 600 which includes placing beads in an air dryer for 24 hours at room temperature and to obtain semi-dry beads and a step 700 which includes placing the semi-dry beads in a desiccator for 64 hours to obtain dry beads. In each case, a determination of total CFU 750 and a measurement of water a_{w} 760 were performed on the dry beads. Dry beads having a water activity a_{w} of ≤0.3 were obtained.

In each case, and with reference to FIG. 2, the a_{w} fold reduction was calculated according to the following:

$${a}_{w} fold reduction = \frac{650 - 760}{650}$$

In each case, and with reference to FIG. 2, viability loss (CFU log loss) was calculated according to the following:

CFU loss=log₁₀(550)−log₁₀(750)

In each case, an average viability loss and normalized average viability loss relative to the results obtained with preservation solution S1 was calculated.

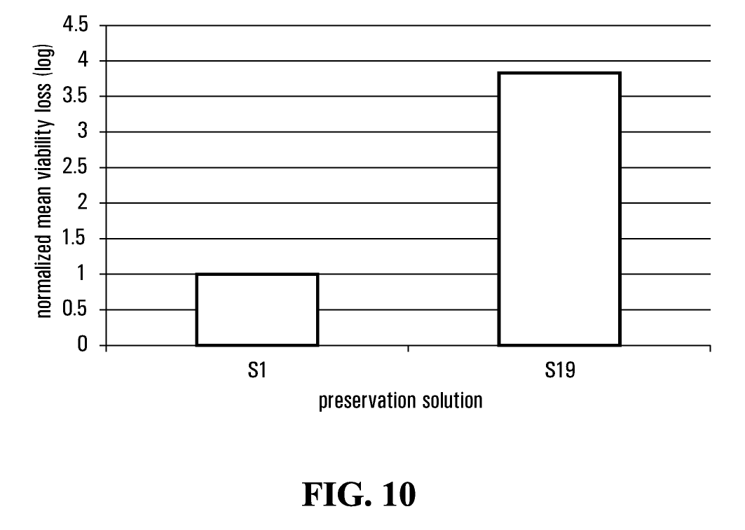

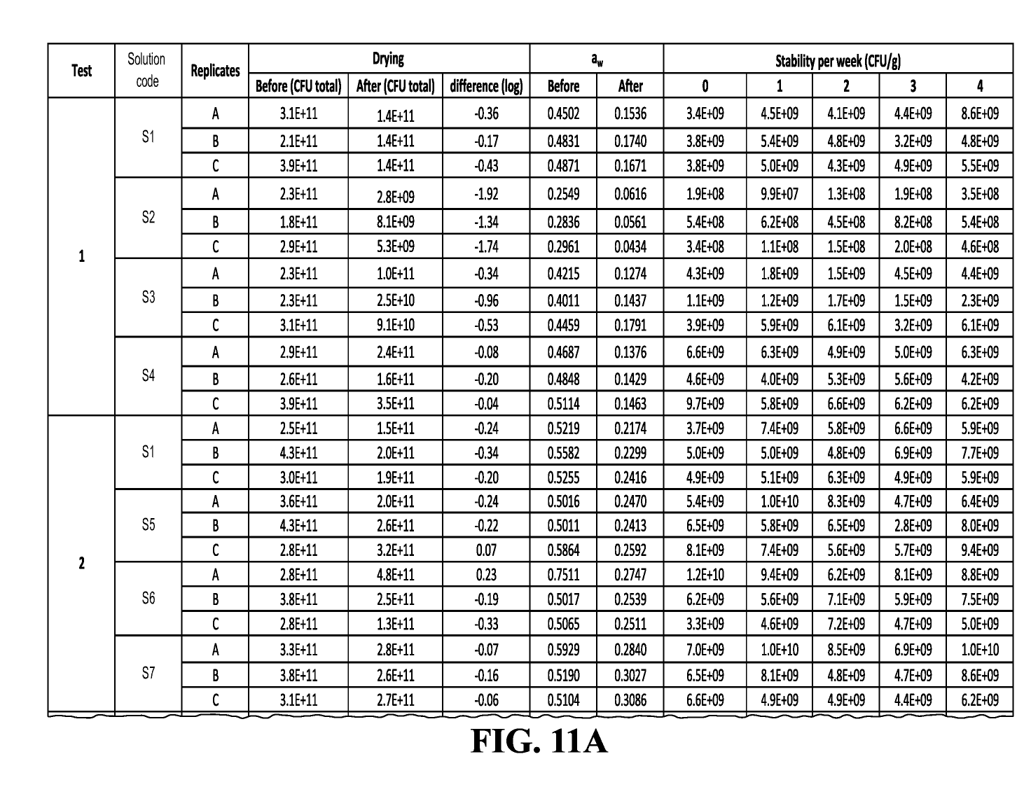

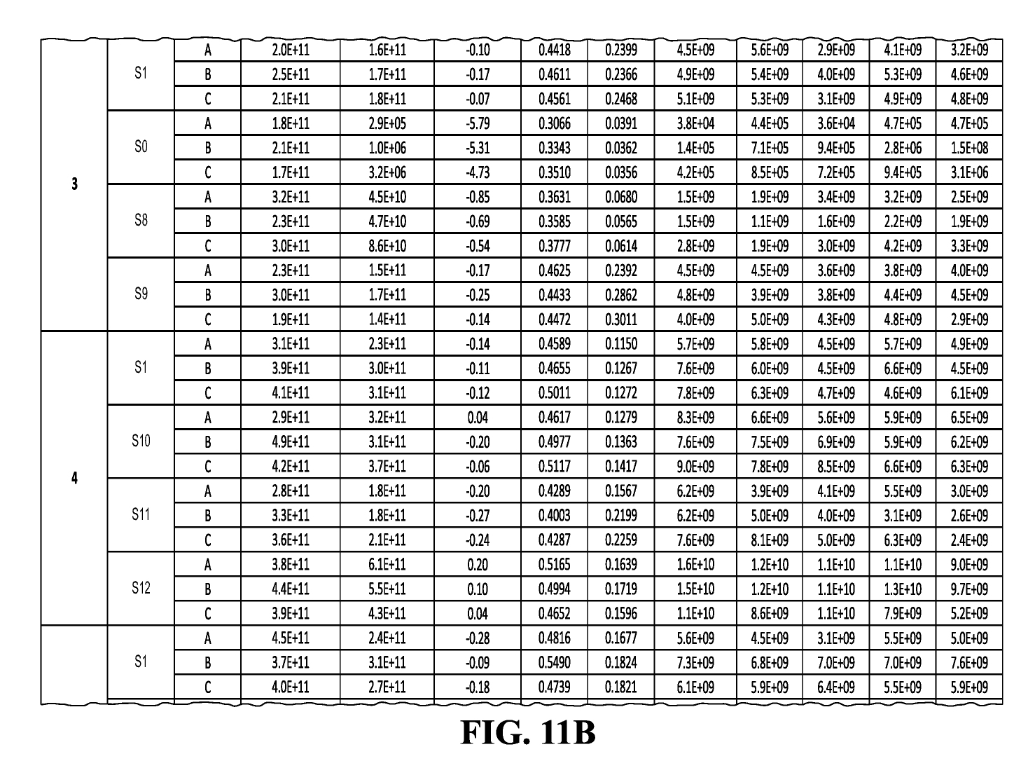

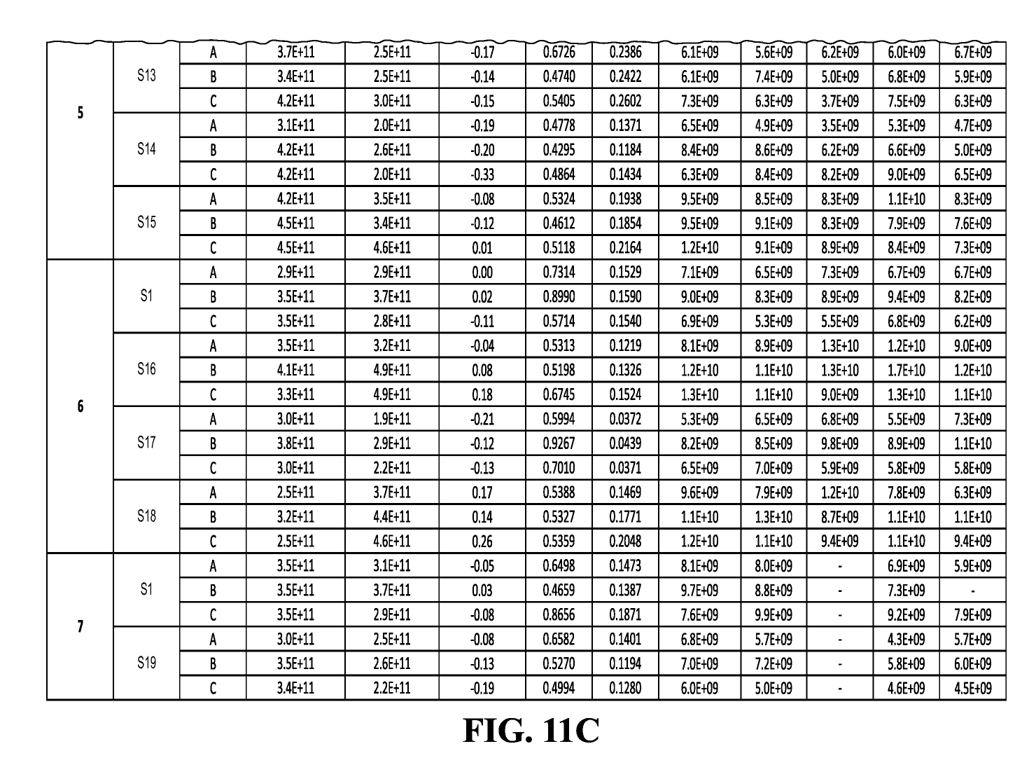

The results are shown in FIG. 10.

A compilation of the results of Example 7 is set forth in Tables 14 and 15.

TABLE 14

| | | step 750 | | |
|---|---|---|---|---|
| | | | average | Normalized |
| | step 550 | | CFU loss | CFU loss |
| Sample | average CFU | average CFU | (log₁₀) | (log₁₀) |
| S1 | 3.5 × 10¹¹ ± 4.4 × 10⁸ | 3.2 × 10¹¹ ± 4.13 × 10¹⁰ | 0.03 ± 0.05 | 1 |
| S19 | 3.3 × 10¹¹ ± 2.6 × 10¹⁰ | 2.4 × 10¹¹ ± 2.06 × 10¹⁰ | 0.13 ± 0.06 | 3.83 |

TABLE 15

step 760

| | step 650 | | a_{w} fold |
|---|---|---|---|
| Sample | average a_{w} | average a_{w} | reduction |
| S1 | 0.660 ± 0.200 | 0.158 ± 0.026 | 0.76 |
| S19 | 0.561 ± 0.085 | 0.129 ± 0.010 | 0.77 |

### 8. Example 8

For each preservation solution tested here, the drying and testing was performed at least in triplicates. Beads prepared as in Example 1 were placed in a preservation solution S1, a preservation solution S2, a preservation solution S3 and a preservation solution S4 with gentle stirring for about 20 minutes. The beads were then placed on a tray dryer in an air dryer at room temperature for about 24 h to obtain semi-dry beads. The semi-dry beads were then placed in a desiccator for about 64 h, in which dry and filtered air was blown. Dry beads having a water activity a_{w} of ≤0.3 were obtained.

In each case, the strain viability was tested over a period of four (4) weeks under storage conditions at 4° C. by measuring the CFU/g of the dried beads. The tests were performed at least in triplicates and one standard deviation was calculated.

The results of Example 8 are shown in Table 16 where all the preservation solutions tested afforded feed additive strain stability during at least 4 weeks when stored at 4° C.

TABLE 16

| | Difference CFU/g |
|---|---|
| Preservation solution | after 4 weeks (log) |
| S1 | 0.2 |
| S2 | 0.1 |
| S3 | 0.1 |
| S4 | 0 |

### 9. Example 9

For each preservation solution tested here, the drying and testing was performed at least in triplicates. Beads prepared as in Example 1 were placed in a preservation solution S1, a preservation solution S5, a preservation solution S6 and a preservation solution S7 with gentle stirring for about 20 minutes. The beads were then placed on a tray dryer in an air dryer at room temperature for about 24 h to obtain semi-dry beads. The semi-dry beads were then placed in a desiccator for about 64 h, in which dry and filtered air was blown. Dry beads having a water activity a_{w} of ≤0.3 were obtained.

In each case, the strain viability was tested over a period of four (4) weeks under storage conditions at 4° C. by measuring the CFU/g of the dried beads. The tests were performed at least in triplicates and one standard deviation was calculated.

The results of Example 9 are shown in Table 17 and all the preservation solutions tested afforded feed additive strain stability during at least 4 weeks when stored at 4° C.

TABLE 17

| | Difference CFU/g |
|---|---|
| Preservation solution | after 4 weeks (log) |
| S1 | 0.2 |
| S5 | 0.1 |
| S6 | 0 |
| S7 | 0.1 |

### 10. Example 10

For each preservation solution tested here, the drying and testing was performed at least in triplicates. Beads prepared as in Example 1 were placed in either a preservation solution S1, a preservation solution S0, a preservation solution S8 and a preservation solution S9 with gentle stirring for about 20 minutes. The beads were then placed on a tray dryer in an air dryer at room temperature for about 24 h to obtain semi-dry beads. The semi-dry beads were then placed in a desiccator for about 64 h, in which dry and filtered air was blown. Dry beads having a water activity a_{w} of ≤0.3 were obtained.

In each case, the strain viability was tested over a period of four (4) weeks under storage conditions at 4° C. by measuring the CFU/g of the dried beads. The tests were performed at least in triplicates and one standard deviation was calculated.

The results of Example 10 are shown in Table 18 and all the preservation solutions tested afforded feed additive strain stability during at least 4 weeks when stored at 4° C.

TABLE 18

| | Difference CFU/g |
|---|---|
| Preservation solution | after 4 weeks (log) |
| S1 | 0 |
| S0 | 2.4 |
| S8 | 0.1 |
| S9 | 0 |

### 11. Example 11

For each preservation solution tested here, the drying and testing was performed at least in triplicates. Beads prepared as in Example 1 were placed in either a preservation solution S1, a preservation solution S10, a preservation solution S11 and a preservation solution S12 with gentle stirring for about 20 minutes. The beads were then placed on a tray dryer in an air dryer at room temperature for about 24 h to obtain semi-dry beads. The semi-dry beads were then placed in a desiccator for about 64 h, in which dry and filtered air was blown. Dry beads having a water activity a_{w} of ≤0.3 were obtained.

In each case, the strain viability was tested over a period of four (4) weeks under storage conditions at 4° C. by measuring the CFU/g of the dried beads. The tests were performed at least in triplicates and one standard deviation was calculated.

The results of Example 11 are shown in Table 19 and all the preservation solutions tested afforded feed additive strain stability during at least 4 weeks when stored at 4° C.

TABLE 19

| | Difference CFU/g |
|---|---|
| Preservation solution | after 4 weeks (log) |
| S1 | 0.1 |
| S10 | 0.1 |
| S11 | 0.4 |
| S12 | 0.2 |

### 12. Example 12

For each preservation solution tested here, the drying and testing was performed at least in triplicates. Beads prepared as in Example 1 were placed in either a preservation solution S1, a preservation solution S13, a preservation solution S14 and a preservation solution S15 with gentle stirring for about 20 minutes. The beads were then placed on a tray dryer in an air dryer at room temperature for about 24 h to obtain semi-dry beads. The semi-dry beads were then placed in a desiccator for about 64 h, in which dry and filtered air was blown. Dry beads having a water activity a_{w} of ≤0.3 were obtained.

In each case, the strain viability was tested over a period of four (4) weeks under storage conditions at 4° C. by measuring the CFU/g of the dried beads. The tests were performed at least in triplicates and one standard deviation was calculated.

The results of Example 12 are shown in Table 20 and all the preservation solutions tested afforded feed additive strain stability during 4 weeks when stored at 4° C.

TABLE 20

| | Difference CFU/g |
|---|---|
| Preservation solution | after 4 weeks (log) |
| S1 | 0 |
| S13 | 0 |
| S14 | 0.1 |
| S15 | 0.1 |

### 13. Example 13

For each preservation solution tested here, the drying and testing was performed at least in triplicates. Beads prepared as in Example 1 were placed in either a preservation solution S1, a preservation solution S16, a preservation solution S17 and a preservation solution S18 with gentle stirring for about 20 minutes. The beads were then placed on a tray dryer in an air dryer at room temperature for about 24 h to obtain semi-dry beads. The semi-dry beads were then placed in a desiccator for about 64 h, in which dry and filtered air was blown. Dry beads having a water activity a_{w} of ≤0.3 were obtained.

In each case, the strain viability was tested over a period of four (4) weeks under storage conditions at 4° C. by measuring the CFU/g of the dried beads. The tests were performed at least in triplicates and one standard deviation was calculated.

The results of Example 13 are shown in Table 21 and all the preservation solutions tested afforded feed additive strain stability during at least 4 weeks when stored at 4° C.

TABLE 21

| | Difference CFU/g |
|---|---|
| Preservation solution | after 4 weeks (log) |
| S1 | 0 |
| S16 | 0 |
| S17 | 0 |
| S18 | 0.1 |

### 14. Example 14

For each preservation solution tested here, the drying and testing was performed at least in triplicates. Beads prepared as in Example 1 were placed in either a preservation solution S1 or a preservation solution S19 with gentle stirring for about 20 minutes. The beads were then placed on a tray dryer in an air dryer at room temperature for about 24 h to obtain semi-dry beads. The semi-dry beads were then placed in a desiccator for about 64 h, in which dry and filtered air was blown. Dry beads having a water activity a_{w} of ≤0.3 were obtained.

In each case, the strain viability was tested over a period of four (4) weeks under storage conditions at 4° C. by measuring the CFU/g of the dried beads. The tests were performed at least in triplicates and one standard deviation was calculated.

The results are shown in Table 22 and all the preservation solutions tested afforded feed additive strain stability during at least 4 weeks when stored at 4° C.

TABLE 22

| | Difference CFU/g |
|---|---|
| Preservation solution | after 4 weeks (log) |
| S1 | 0.1 |
| S19 | 0.1 |

### 15. Example 15

This example describes a variant process for making a feed additive in accordance with an embodiment of the present disclosure. In this example, bacteria are encapsulated in a matrix made of alginate-calcium according to two different methods of production, namely a 6-step process as described in Example 1 or a 4-step process as described in the following. The alginate-calcium matrix is in the form of particles, which can have a heterogeneous or homogeneous mean diameter size depending on the application. Because the beads are made with liquid bacterial culture as starting material, the person of skill will understand that the final composition of the herein described dried E. coli beads may include components of the bacterial culture media.

The 6-step process includes the following steps:
Step 1: E. coli cultures
Step 2: Preparation of bacteria/alginate slurry
Step 3: Bead formation and polymerization
Step 4: Bead washing
Step 5: Contacting with preservative solution
Step 6: Drying

The 4-step process includes the following steps:
Step 1: E. coli cultures
Step 2: Preparation of bacteria/alginate slurry
Step 3: Bead formation and polymerization
Step 6: Drying
   a. E. coli Culture

In this example, the E. coli strain was prepared as in Example 1.

The resulting culture was then kept at 4° C. for 14 to 18 hours without agitation before being used for the production of feed additive or frozen at −80° C. Prior to freezing, one part of the culture was mixed with one part of a preservative solution and one part of fresh culture medium (i.e., in a ratio of 1:1:1). The preservative solution included 15 wt/v % maltodextrin, 21 wt/v % sucrose, and 3 wt/v % monosodium L-glutamate.

b. Embedding E. coli in Matrix

In the following paragraphs, the E. coli is embedded in the matrix by first preparing an alginate/bacterial slurry, and then forming particles therefrom. Two variants are described, a 6-step process and a 4-step process.

### 6-Step Process

One part of the bacterial culture (e.g., 500 ml) was blended with 2 parts of culture medium (e.g., 1 L) and 3 parts of alginate solution (2 wt/v % Grindsted® Alginate FD155, 0.1 wt/v % Bacto™ peptone) (e.g., 1.5 L) to obtain a slurry.

The alginate-bacterial culture slurry was then pumped through a system holding 27 needles (20 G, ½ inches), which was adapted using three 9-port Thermo Scientific™ Reacti-Vap™ Evaporator, at a speed that allow the liquid to fall drop-by-drop in an 18-L tank containing 12 litres of calcium chloride polymerization solution (300 mM CaCl₂, 0.1 wt/v % Bacto™ tryptone, 0.1 wt/v % Bacto™ peptone, and 0.05 wt/v % g Bacto™ yeast extract in water) to form particle beads. The polymerization solution was stirred slowly to ensure that beads do not collapse. Once the entire alginate-culture slurry was transferred into the polymerization solution, beads were kept in the solution for an additional 30 minutes, under slow stirring, to complete the polymerization process.

After polymerization, the particle beads were drained off the polymerization solution and soaked for 10 minutes in the washing solution (50 mM CaCl₂).

Beads were drained, weighed, and soaked in the preservative solution (10 wt/v % dextran 40, 14 wt/v % sucrose, 2 wt/v % monosodium L-glutamate) at a ratio of 1 ml solution per gram of beads, under agitation for 20 minutes. Finally, beads were drained and dried.

An additional experiment was also performed using the same method but with 14 wt/v sucrose only in the soaking solution, with similar results.

### 4-Step Process

One part of the bacterial culture (e.g., 500 ml) was blended with 1 part of the preservative solution (15 wt/v % maltodextrin, 21 wt/v % sucrose, 3 wt/v % monosodium L-glutamate) (e.g., 500 ml), 1 part of culture medium (e.g., 500 ml), and 3 parts of alginate solution (2 wt/v % Grindsted® Alginate FD155, 0.1 wt/v % Bacto™ peptone) (e.g., 1.5 L) to obtain a slurry.

The alginate-bacterial culture slurry was then pumped through a system holding 27 needles (20 G, ½ inches), which was adapted using three 9-port Thermo Scientific™ Reacti-Vap™ Evaporator, at a speed that allowed the liquid to fall drop-by-drop in an 18-L tank containing 12 litres of calcium lactate polymerization solution (5 wt/v % calcium lactate) to form particle beads. The polymerization solution was stirred slowly to ensure that beads did not collapse. Once the entire alginate-culture slurry was transferred into the polymerization solution, beads were kept in the solution for an additional 30 minutes to 4 hours, under slow stirring, to complete the polymerization process. A powdery calcium-containing residue was observed forming a particulate coating on at least a portion of the surface of the beads.

c. Drying and Testing of Embedded E. coli

Particle beads were placed in an aluminum tray and dispersed to obtain a layer of beads with a depth of ≤1.5 cm. Particle beads were then air dried as in Example 1. Particle beads weight before and after drying was used to calculate the loss on drying.

A compilation of the results of Example 15 is set forth in the following tables. These results demonstrate that the six (6) step process and the four (4) step process provided a significant effect to the viability of the E. coli embedded in the dried matrix and its resistance to the drying process.

The 4-step process was developed to optimize the 6-step process, saving on materials and reducing processing time. A key requirement was to ensure that the bacteria survive the drying step. In order to achieve this, in the 6-step process, the particles were contacted with the preservative solution before drying the beads.

A first prototype 4-step process was tested by the present inventor. In this prototype 4-step process, the inventor tested whether it was possible to delete the contacting with the preservative solution step and, instead, added the preservative solution into the bacterial/alginate slurry, before bead formation and polymerization. This prototype 4-step process was tested with two different preservative solutions: a first preservative solution with dextran 40 and a second preservative solution with maltodextrin (instead of dextran 40). The present inventor also tested whether it was possible to delete the washing step after the polymerization in calcium chloride.

The results reported in Table 23A show that in the first prototype 4-step process, deleting the washing step causes significant CFU loss in dried beads.

While keeping the washing step gave better results, CFU counts in the dried particle beads were still lower than for the 6-step process by over 1 log₁₀ (3.9×10⁸ versus 5.9×10⁹ CFU/g on average). The first prototype 4-step process tested with dextran 40 gave similar results than with maltodextrin. One main difference between beads resulting from the first prototype 4-step process was the extent of the drying process. Indeed, deleting the washing/contacting with preservative steps before the drying step resulted in particle beads that lost 92-95% of its mass upon drying. Contrast this with the case where the process includes the washing/contacting with preservative steps and the resulting particle beads lost 85% of their mass (Table 23).

TABLE 23
Results of live E. coli count (CFU/g dried beads) and
bead weight loss on drying for beads obtained with a 6-step
process and beads obtained with a 4-step process in accordance
with an embodiment of the present disclosure.

After drying

| | Before drying | Bead | | E. coli |
|---|---|---|---|---|
| | E. coli | weight loss | E. coli | loss |
| | count | on drying | count | (log₁₀ |
| Steps | (CFU/g) | (%) | (CFU/g) | CFU) |
| 6 | 1.3 × 10⁹ | 85 | 5.9 × 10⁹ | 0.26 |
| 4 | 2.7 × 10⁹ | 92 | 1.9 × 10¹⁰ | 0.17 |

TABLE 23A
Results of live E. coli count (CFU/g dried beads) and bead weight
loss on drying for beads obtained with a 4-step process in accordance
with an embodiment of the present disclosure, and to evaluate the
impact of performing the washing step before the drying step

| Preservative with | | Bead weight | E. coli count |
|---|---|---|---|
| dextran 40 or | Bead washing | loss on drying | in dried beads |
| maltodextrin | before drying | (%) | (CFU/g) |
| Dextran 40 | Yes | 95 | 3.9 × 10⁸ |
| Dextran 40 | No | 92 | <2.0 × 10⁷ |
| Maltodextrin | Yes | 95 | 3.7 × 10⁸ |
| Maltodextrin | No | 92 | <2.0 × 10⁷ |

In an industrial setting, the polymerization process and the period of time that particle beads are in contact with the polymerization solution may vary greatly during the manufacturing process. Indeed, the processing path may more or less vary, based on various conditions such as the industrial machinery used and the batch size, thus affecting the processing time, including the period of time where the particle beads are in contact with the polymerization solution. In a particular practical implementation, such variability may affect the period of time required between the step of making the slurry and the step of dropping the slurry from the needle to form the particle beads.

In a second prototype 4-step process, the inventor tested the effect of using different polymerization solutions: a first polymerization solution included calcium chloride and a second polymerization solution included calcium lactate. The inventor also tested various contacting time with the polymerization solutions, namely 1 h, 3 h or 4 h.

The results reported in Table 24 show that in the second prototype 4-step process, calcium lactate provided superior results compared to calcium chloride, suggesting that the former is more suitable than the latter when reducing the number of steps in the process. This difference was more significant when the polymerization time was increased to 3 h, i.e., increasing the contacting time with the polymerization solution.

TABLE 24
Live E. coli count (CFU/g dried beads) and bead weight
loss on drying results to evaluate different polymerization
solution (step 3) and time followed or not by a soaking
step in a sucrose solution (step 5).

| | Polymer- | | Bead weight | E. coli count |
|---|---|---|---|---|
| | ization | Bead | loss on | in dried |
| Polymerization | time | soaking in | drying | beads |
| solution | (Hours) | sucrose | (%) | (CFU/g) |
| Calcium chloride | 1 | Yes | 91 | 1.8 × 10⁸ |
| and media | 3 | | 91 | 6.8 × 10⁷ |
| Calcium chloride | 1 | Yes | 91 | 1.9 × 10⁸ |
| only | 3 | | 91 | 7.4 × 10⁷ |
| Calcium lactate | 1 | No | 92 | 3.1 × 10⁹ |
| | 3 | | 92 | 1.5 × 10⁹ |

The inventor also tested the viability of the bacteria in particle beads when increasing the contacting time with the calcium lactate polymerization solution from 1 h to 4 h. The results reported in Table 25 show that there is no loss of viability during that step, despite increasing the contacting time to 4 h.

TABLE 25
Live E. coli count results (CFU/g bead) to evaluate
the viability of the bacteria in the calcium lactate polymerization
solution over a period of 4 hours at 25° C.

| | |
|---|---|
| Time | E. coli count in beads (n = 3) |

| (hours) | Average CFU/g | Standard Deviation |
|---|---|---|
| 1 | 7.8 × 10⁸ | 1.3 × 10⁸ |
| 4 | 1.9 × 10⁹ | 2.3 × 10⁸ |

The inventor also tested the viability of the bacteria in the slurry (mixture containing alginate, bacterial culture and preservative solution) to determine whether the bacteria would survive an extended period of time under ambient room conditions when put in contact with slurry elements. Two assays were performed; a first assay included the preservative solution in the slurry whereas the second assay did not include the preservative solution in the slurry. The slurry was prepared as described previously and kept under agitation at 25° C. for a 48-hour period. The results reported in Table 26 showed no loss of bacteria CFU after 48 hours when the bacteria were in contact with the preservative solution in the slurry compared when there was no preservative solution in the slurry.

TABLE 26
Live E. coli count results (CFU/ml slurry) to evaluate the viability
of the bacteria in alginate-bacteria slurries, one containing the
preservative made with maltodextrin and a control devoid of such
preservative solution, over a period of 48 hours, at 25° C.

| | E. coli count in slurry (n = 4) | | | |
|---|---|---|---|---|
| | Without preservative solution | | With preservative solution | |
| Time | Average | Standard | Average | Standard |
| (hours) | CFU/ml | Deviation | CFU/ml | Deviation |
| 0 | 2.6 × 10⁸ | 4 × 10⁷ | 2.5 × 10⁸ | 6 × 10⁷ |
| 4 | 3.8 × 10⁸ | 9 × 10⁶ | 4.8 × 10⁸ | 4 × 10⁷ |
| 24 | 7.0 × 10⁸ | 4 × 10⁷ | 5.4 × 10⁸ | 4 × 10⁷ |
| 48 | 2.0 × 10⁸ | 1 × 10⁷ | 1.6 × 10⁹ | 2 × 10⁸ |

Mixing the bacterial culture with the preservative solution before the polymerization step in the proposed 4-step process resulted in a reduction in the number of steps relative to the proposed 6-step process, thus, affording a reduction in industrial production time, material costs, and/or accelerating speed-to-market. Additionally or alternatively, in some cases, it may also be advantageous to implement the 4-step process when required to freeze the E. coli culture (e.g., at −20 or −80° C.) for storage and/or transportation purposes, thus, also affording convenient inventory management applications along the production chain.

Indeed, the inventor analyzed the viability of the bacteria after being frozen at −80° C., placed at −20° C. for 24 hours, and then thawed and kept at 4° C. for 14 days. These kinds of conditions are typically expected during a large-scale industrial process. Results are presented in table 28 and show that the viability of the bacteria is not significantly affected by the freeze-thaw process when the freezing media includes the preservation solution, i.e., viability slowly declines over the 14-day period at 4° C. with a final loss of 0.35 log₁₀.

TABLE 28
Live E. coli count results (CFU/ml) to evaluate the viability
of the bacteria after being mixed with the preservative (made
with maltodextrin), frozen at −80° C., placed at −20°
C. for 24 hours and then thawed and kept at 4° C. for a 14-day period.

| | |
|---|---|
| Time at 4° C. | E. coli count (n = 2) |

| (days) | Average CFU/ml | Standard Deviation |
|---|---|---|
| 0¹ | 5.1 × 10⁸ | Not applicable |
| 1 | 5.5 × 10⁸ | 1 × 10⁷ |
| 2 | 4.8 × 10⁸ | 2 × 10⁶ |
| 7 | 4.1 × 10⁸ | 3 × 10⁷ |
| 8 | 3.3 × 10⁸ | 2 × 10⁷ |
| 14 | 2.3 × 10⁸ | 7 × 10⁷ |

¹This time point corresponds to the analysis done with one sample just before freezing at −80° C.

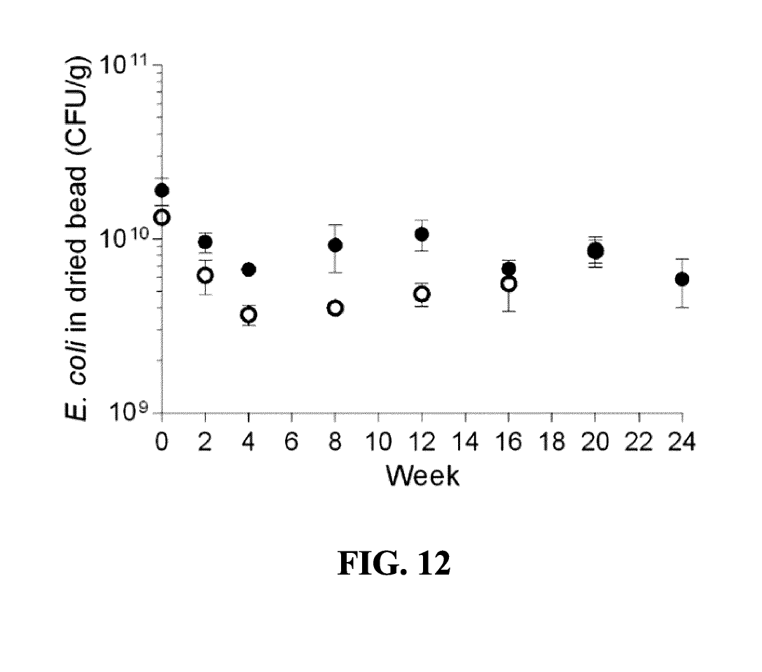

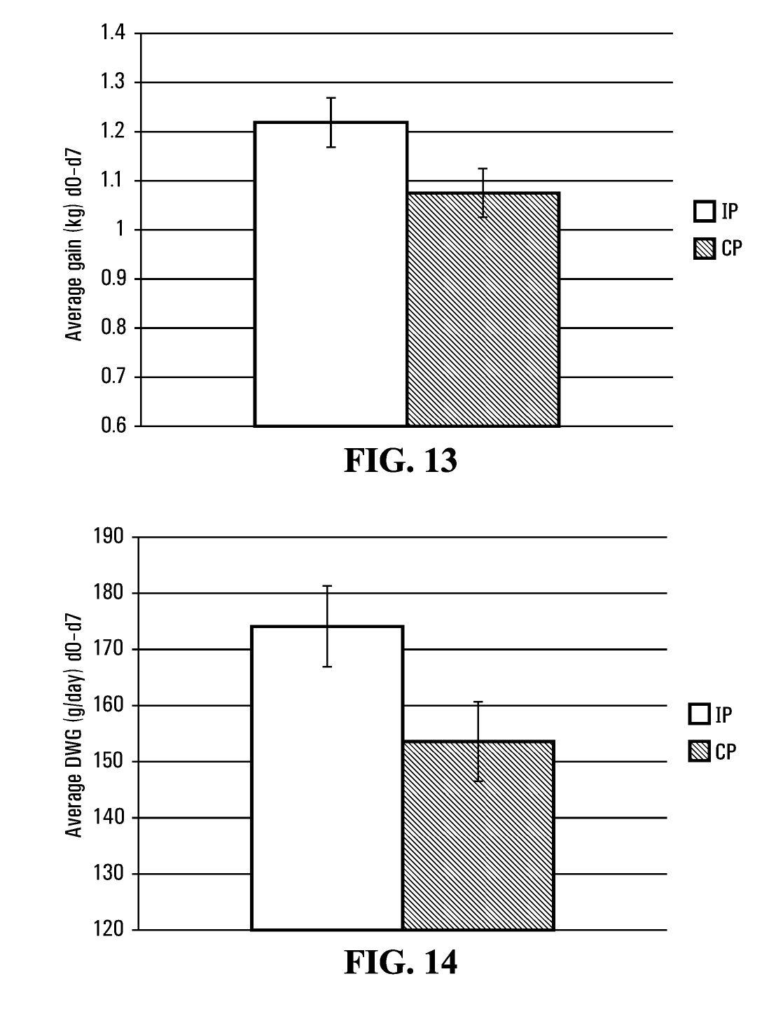

The inventor also tested the stability of the dried bacteria in the feed additive over time alone or in pelleted animal (swine) feed, under storage conditions at 25° C. FIG. 12 shows that after 24 weeks of storage, the dried bacteria in the feed additive (particle beads) are relatively stable.

### 16. Example 16

In the present example, the animal feed additive was incorporated into animal feed in accordance with an embodiment of the present disclosure. In this example, the inventor demonstrates that such animal feed can be obtained with sufficient viable non-pathogenic E. coli to obtain a desired benefit from this E. coli.

In this example, the inventor incorporated the E. coli strain deposited at the International Depository Authority of Canada (IDAC) on Jan. 21, 2005 under accession number IDAC 210105-01 described in U.S. Pat. No. 7,981,411 (incorporated herein by reference in its entirety). This E. coli is known to promote weight gain in an animal following intestinal delivery. The aim of the test was thus to assess whether a feed additive in accordance with an embodiment of the present disclosure sufficiently protected the E. coli strain during the pelleting procedure such that administration of the pelleted animal feed comprising the feed additive would result in administration of sufficient viable E. coli to the animal to demonstrate the expected growth promoting effect.

### 16.1 Animals

128 piglets from a farm in East Lothian, Scotland. Crossbreed of Large White and Landrace of 28 days of age+/−2 days, male and female. The piglets did not receive any treatment active against E. coli within the last three days before the administration of the first diet. Piglets were healthy at arrival (Day 0), weighed from 5.14 kg to 10.04 kg. Animals were numbered individually with a unique ear tag.

### 16.2 Trials

The study was a controlled, randomized, pilot study with two parallel groups, constituting a treated group fed with the Pre-Starter diet with the test strain compared to a control group fed with the Pre-Starter diet without the test strain.

At Day 0, 128 piglets were randomized in 2 groups and pens according to their weaning weight. There were 16 pens of 4 animals for each group. Due to the nature of the test strain active ingredient, a live E. coli strain, the groups were housed per treatment in 2 different rooms (1 room per treatment) with the same environmental conditions. The tested strain was administered as of the start of the assay, i.e., on day 0.

16.3 Evaluated parameters

In the present assays, the parameters evaluated were the average daily gain (ADG) and the overall weight gain on days 0 and 7.

Feed samples were collected for nutritional analysis and to assess the quantity of the feed additive bacteria by live bacterial count.

The piglets' health was monitored daily and adverse events and concomitant medication was recorded. Individual body weights were measured on pre-determined days. The amount of feed intake and the feed weight back was recorded per pen. Rectal swabs were collected on Days 0 and 7 to confirm the presence/absence of the test strain by PCR analysis.

16.4 Animal feed and feed additive

The feed additive was manufactured as described in previous examples, and included the E. coli strain at 6.6×10⁹ CFU/g. This feed additive was stored refrigerated, between 2 to 8° C. and was packaged in 250 g packaging in polyethylene “zipper” seal bags.

The animal feed incorporated a concentration of E. coli strain at 5.4×10⁸ CFU/200 g. This “test” animal feed is also referred to as “pre-starter diet”. The control product was the pre-starter diet without the feed additive.

### 16.5 Administration

The strain was administered through the Pre-starter diet (first feed) at a ratio of 760 g/Ton metric. The Pre-Starter diet was not supplemented with antimicrobials and antimicrobial growth performance promoters (AGP) alternative (organic acids/salts, high levels of Cu/Zn, etc.).

The Pre-Starter diet was supplied for 7 days, from Day 0 to Day 7 of the study.

### 16.6 Results

Analyses confirmed the presence and the quantity of the active ingredient in the Pre-Starter diet animal feed. The tested strain was detected by PCR in feces from all pigs of the treated group and none of the control group.

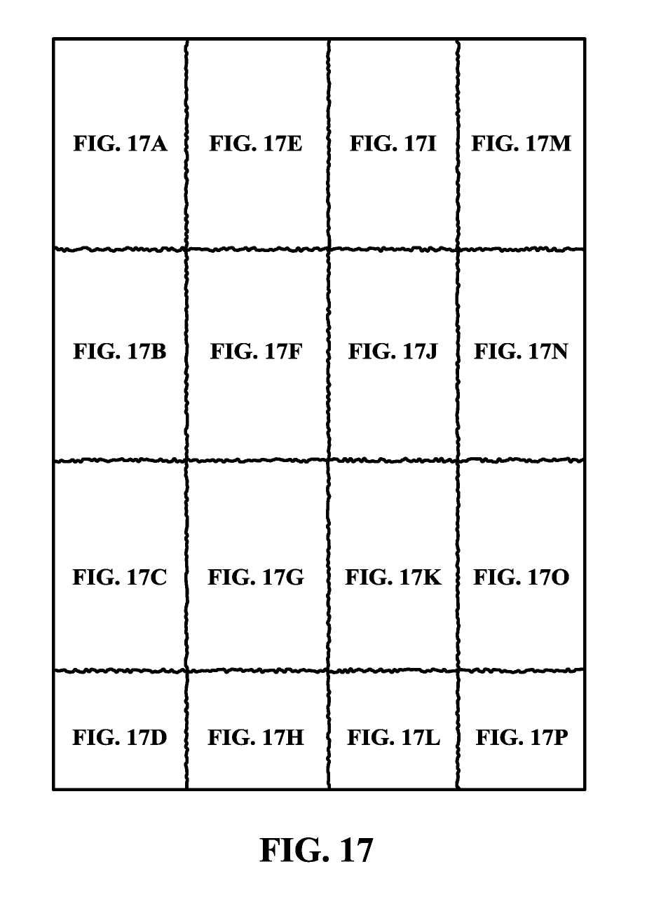

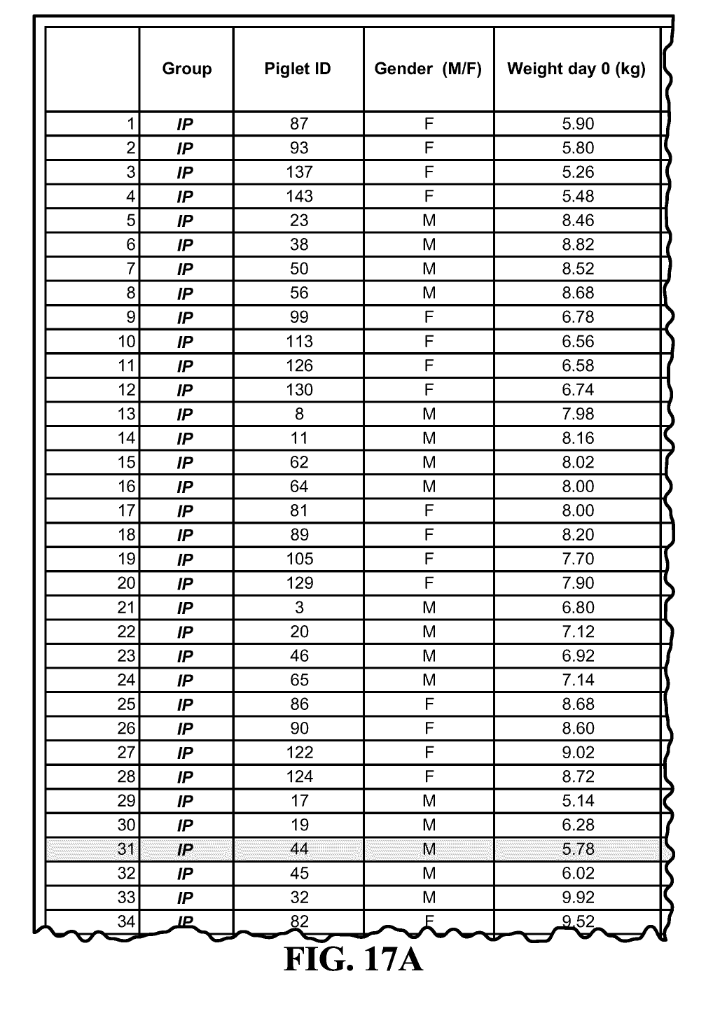

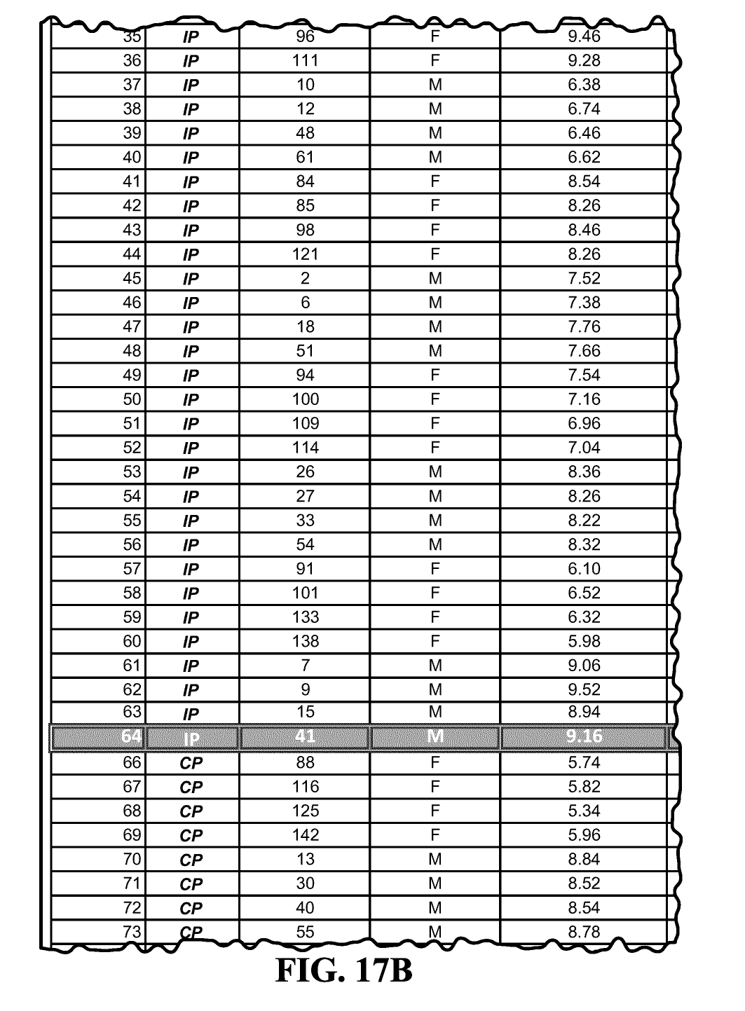

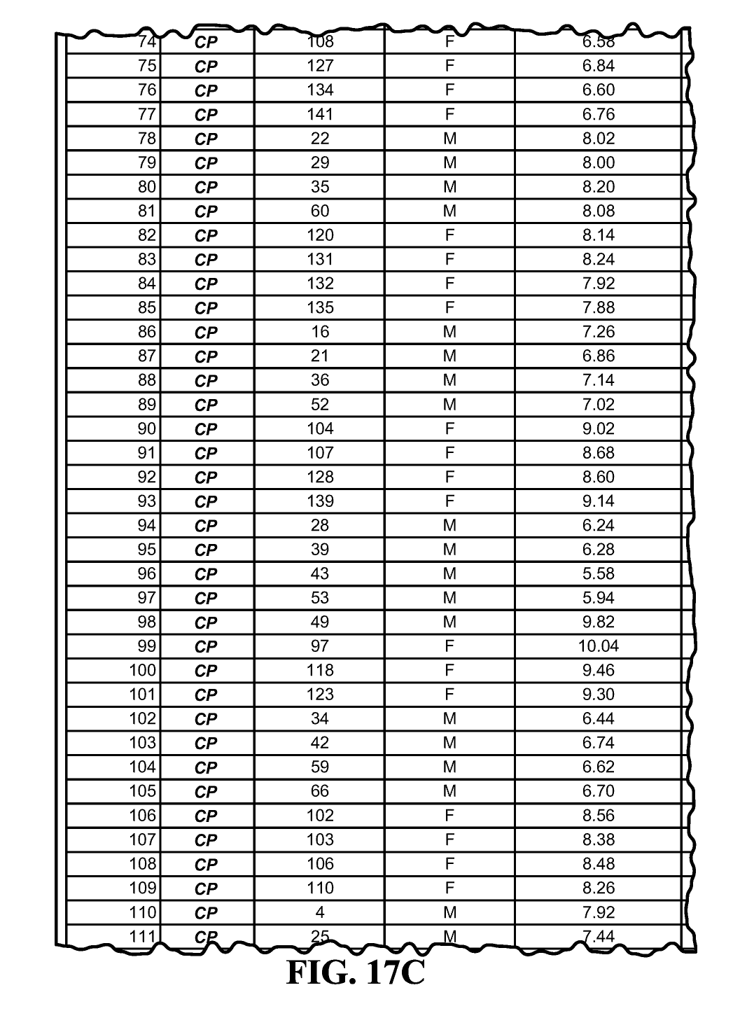

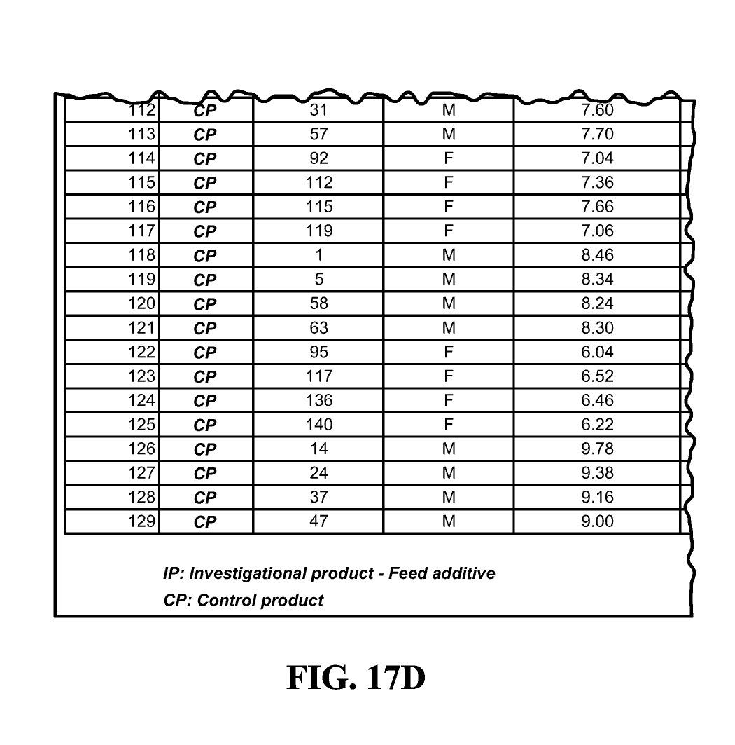

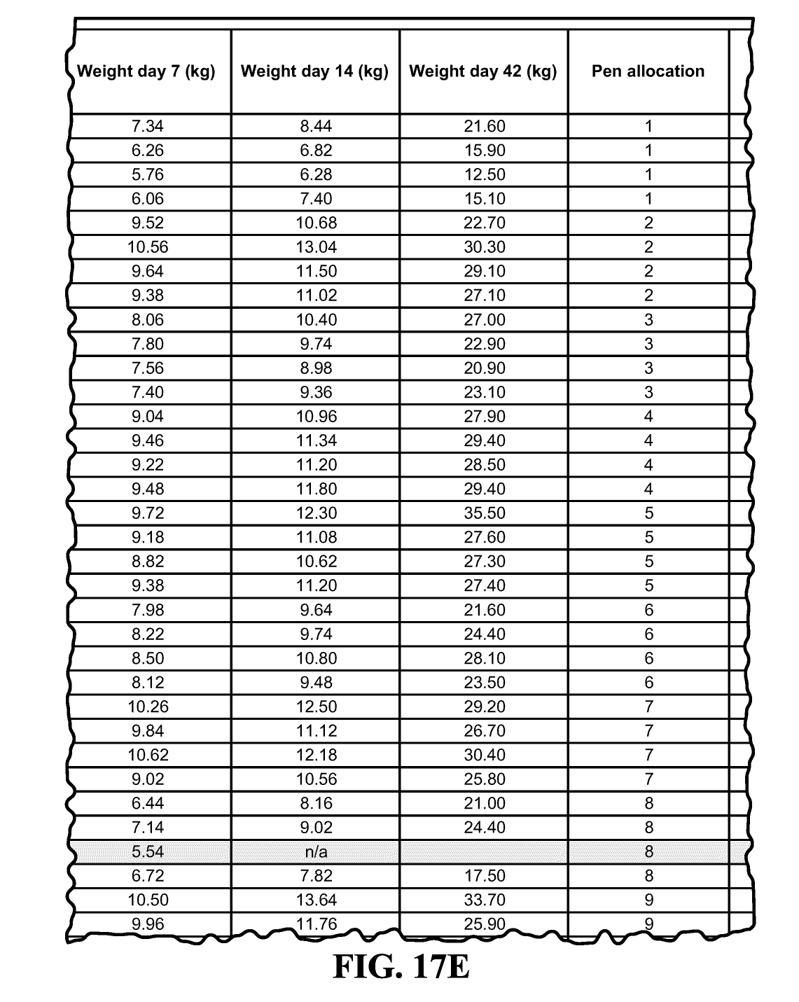

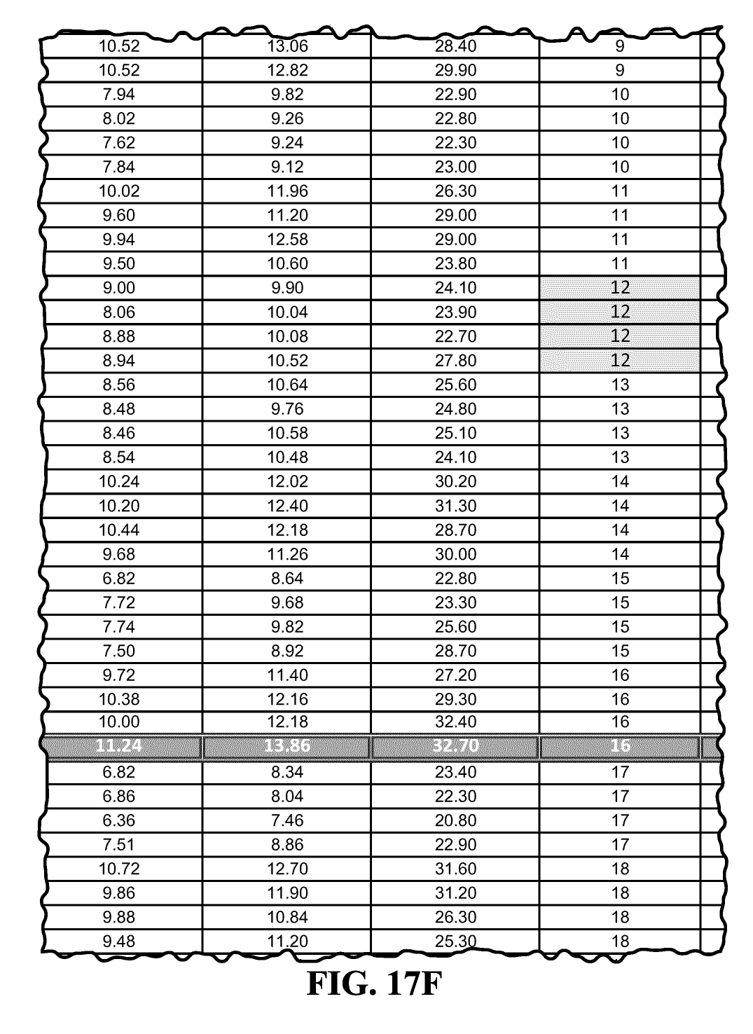

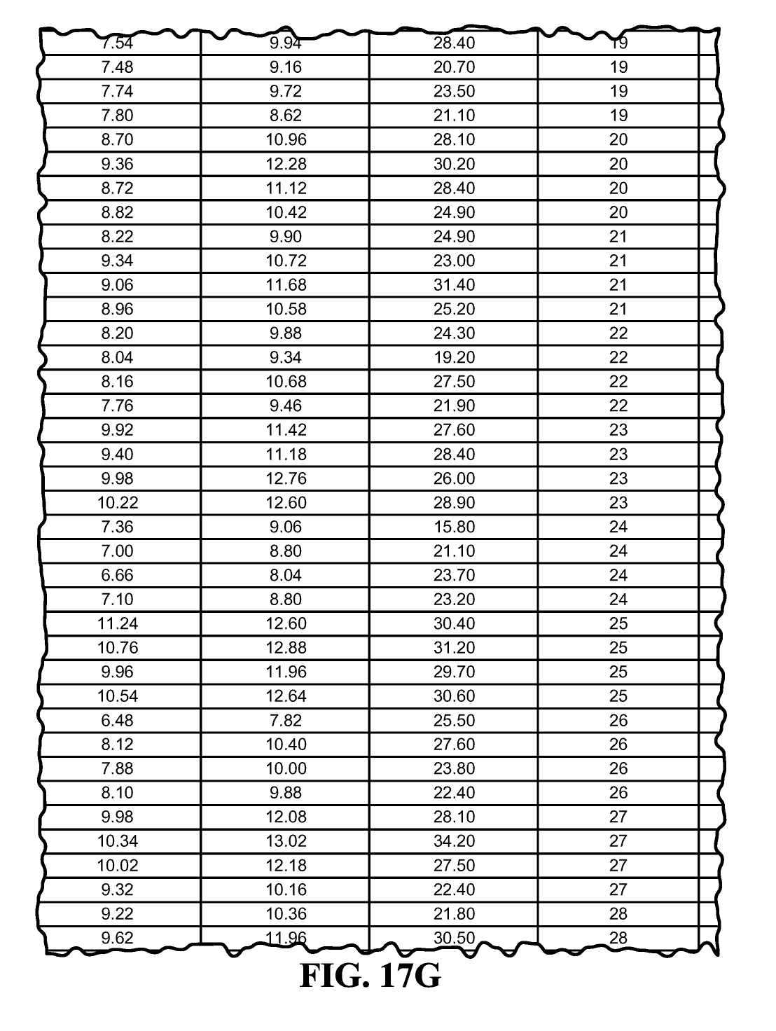

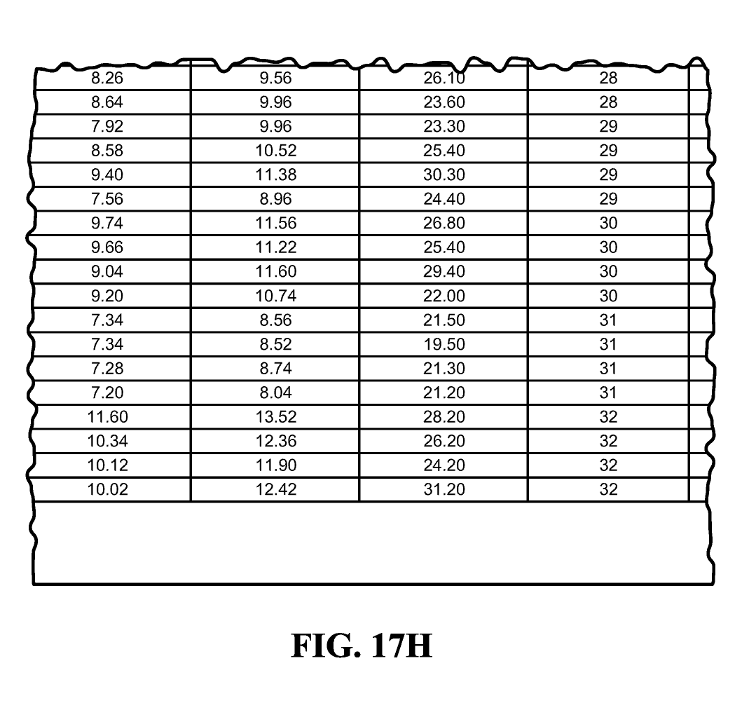

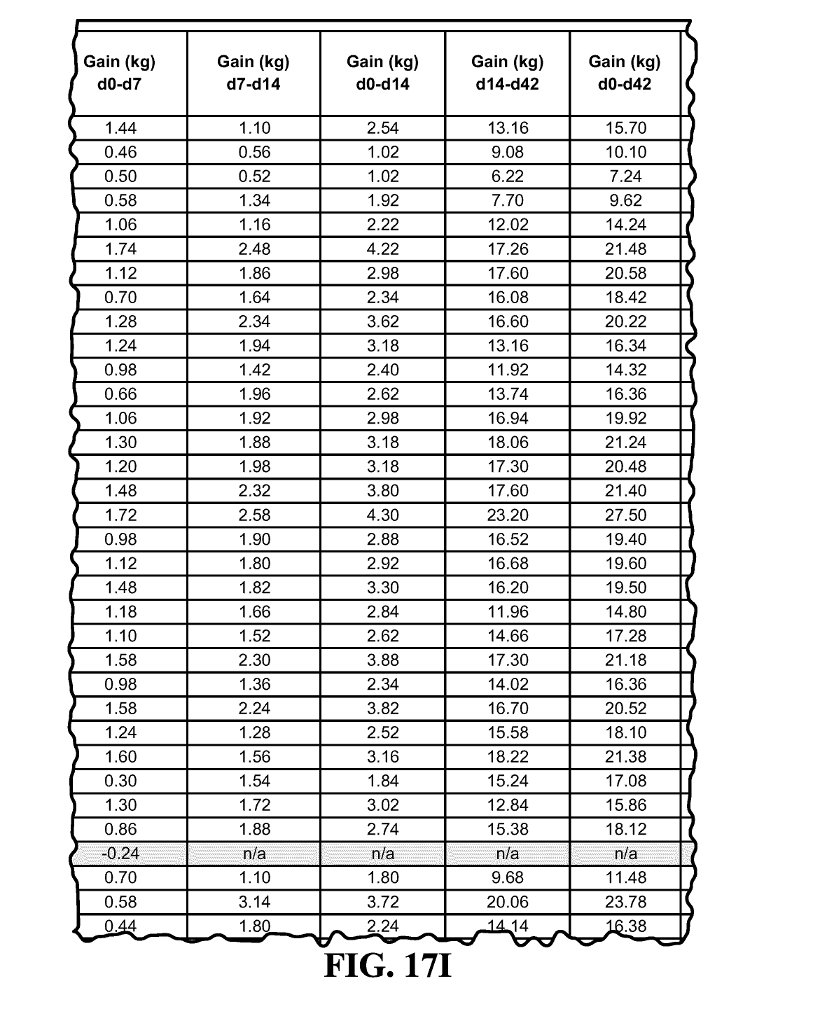

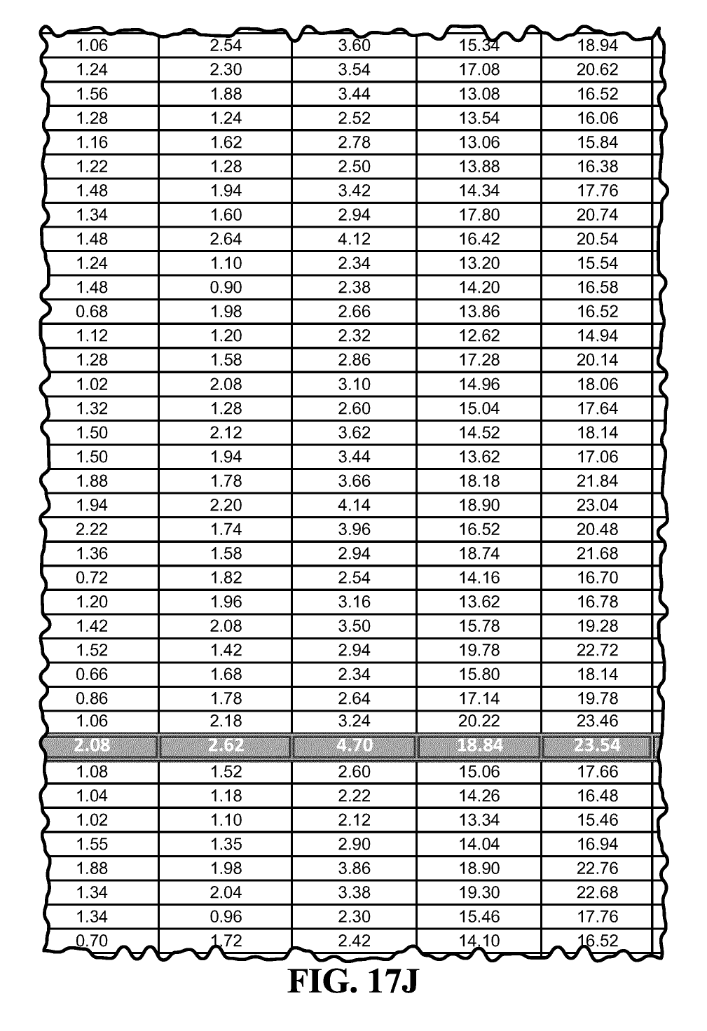

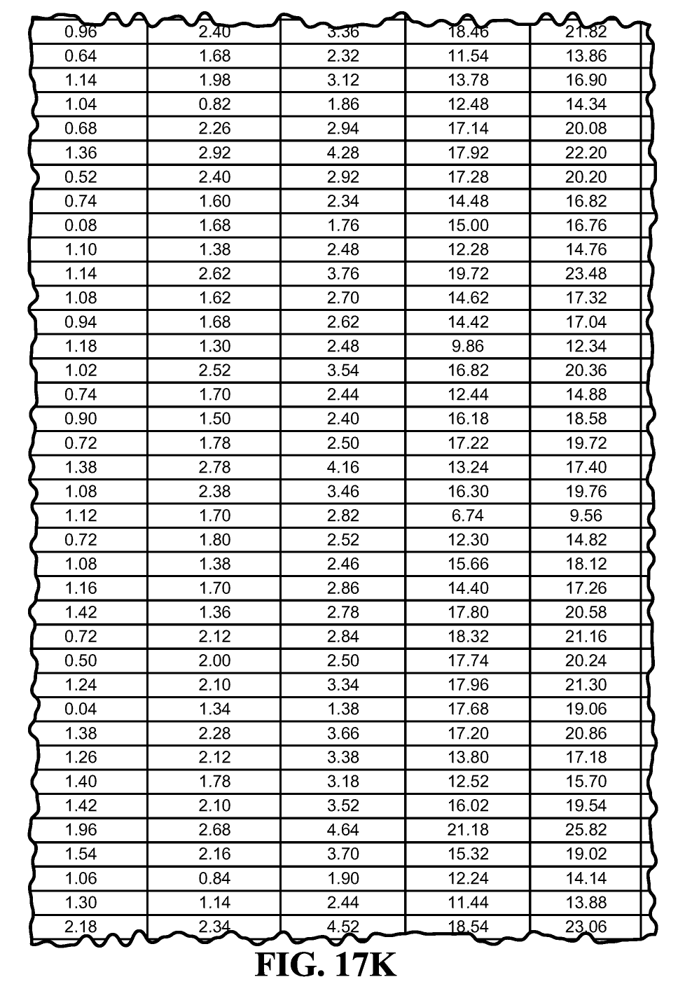

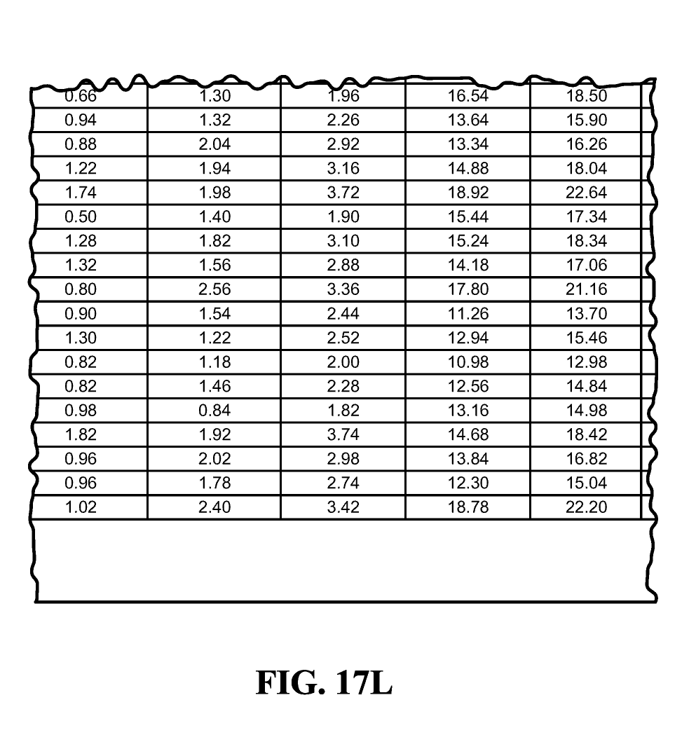

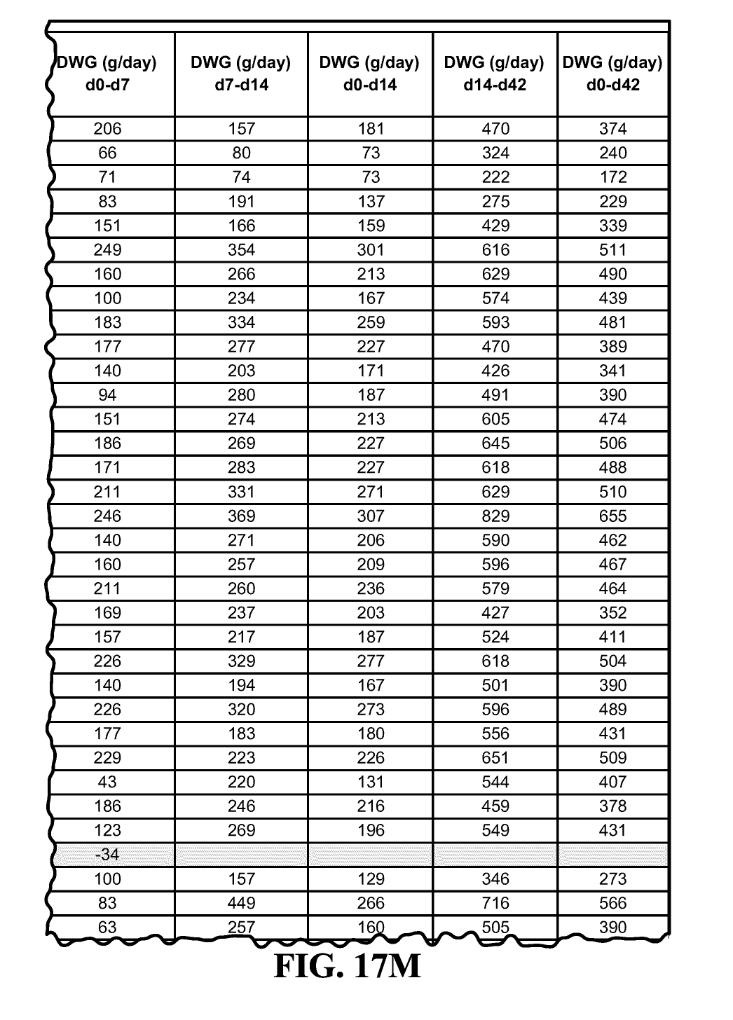

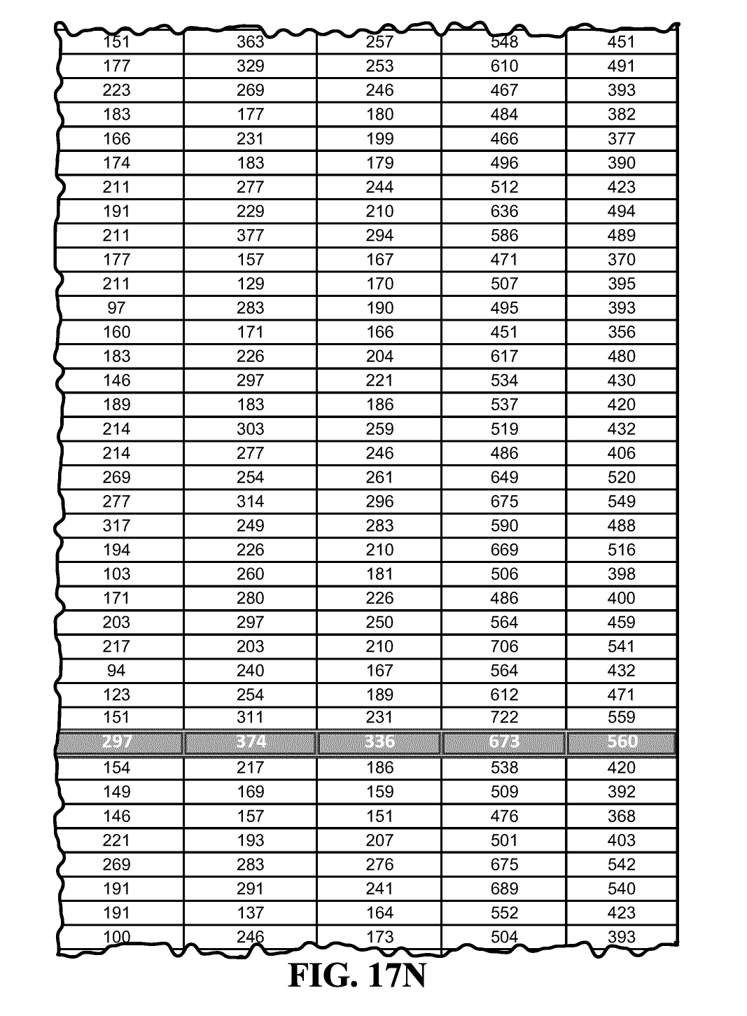

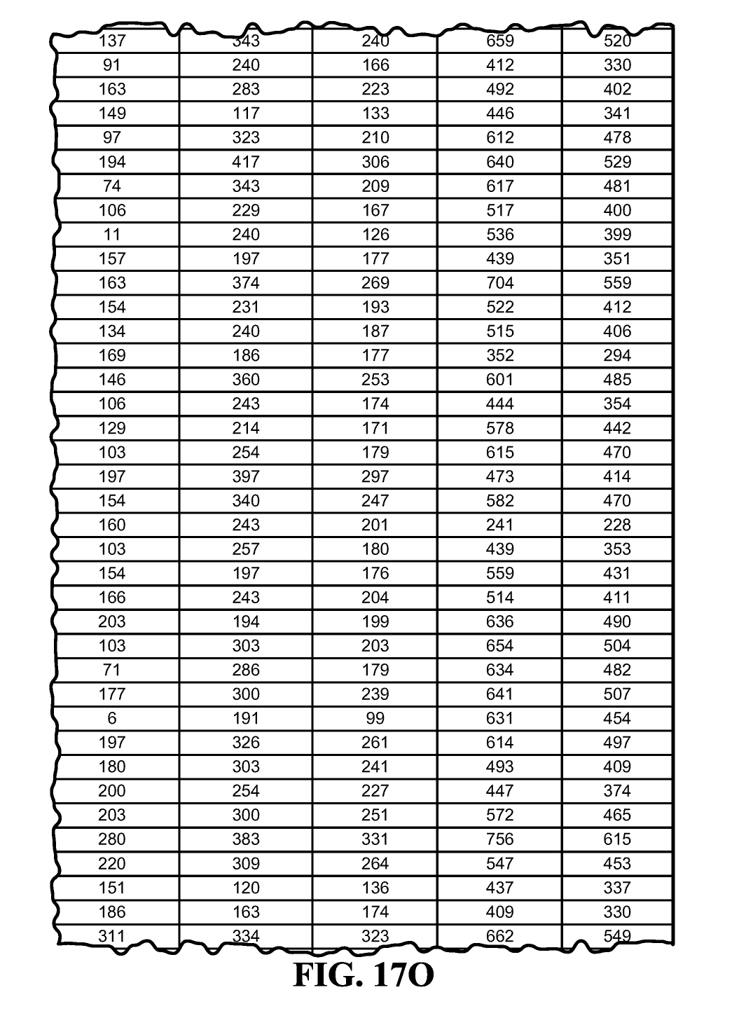

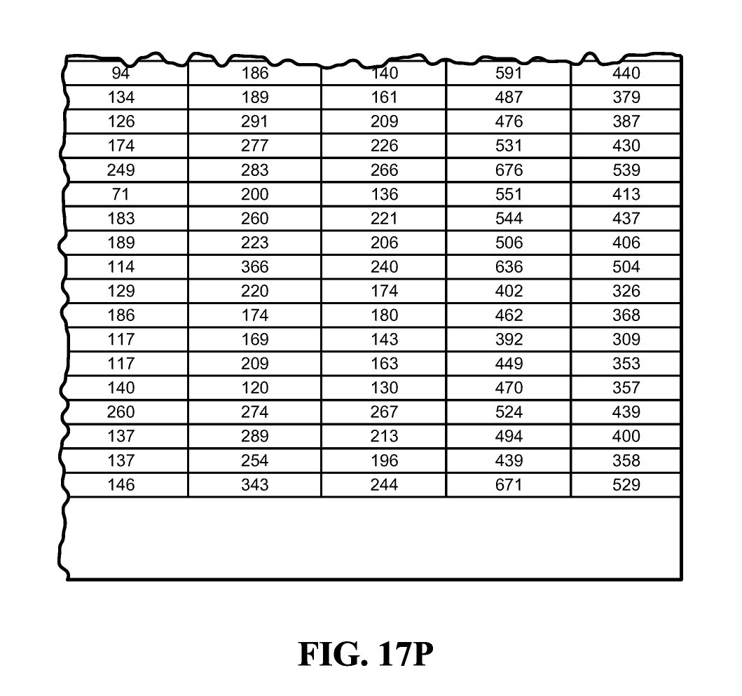

During the assay, as shown in Table 29, after 7 days of consumption of animal feed incorporating the E. coli strain in the feed additive, treated pigs had a weight gain higher by 143 g (21 g per day) when compared to the untreated pigs (p=0.044). The raw data is shown in FIGS. 17A to 17P, and are to be read as shown in FIG. 17.

TABLE 29
Weight gain of the animals (in kg)

| | Test | Control |
|---|---|---|
| Mean | 1.218689 | 1.075156 |
| Variance | 0.154198 | 0.156365 |
| Observations | 61 | 64 |
| Hypothesized Mean Difference | 0 | |
| df | 123 | |
| t Stat | 2.035756 | |
| P(T <= t) one-tail | 0.021961 | |
| t Critical one-tail | 1.657336 | |
| P(T <= t) two-tail | 0.043923 | |
| t Critical two-tail | 1.979439 | |

### 16.7 Analysis and Conclusions

A t-test was performed assuming unequal variances between the two populations. The computed t-value was high enough to reject the null hypothesis (i.e., that there is no significant difference between the two populations), i.e., t Stat>t Critical two-tail with a p-value=0.044. The standard error was then computed for each population and one standard error is shown on respective graphs in FIGS. 13 and 14.

FIG. 13 shows a non-limiting bar graph that depicts the average weight gain (Kg) after 7 days of pigs fed with an animal feed incorporating a feed additive in accordance with an embodiment of the present disclosure (IP) and with an animal feed without feed additive (“CP”). Bar errors depict the standard error (p=0.044). FIG. 14 shows a non-limiting bar graph that depicts the average daily weight gain (g/day) during 7 days of the pigs from FIG. 13. Bar errors depict the standard error (p=0.044).

This effect is in-line with the effect expected upon administration of this strain to a piglet in drinking water as described in U.S. Pat. No. 7,981,411 (incorporated herein by reference in its entirety). In other words, the herein described animal feed incorporating E. coli in a feed additive included sufficient viable E. coli that seemingly did not significantly suffer from the harsh conditions applied during the manufacturing of the animal feed pellets.

Note that titles or subtitles may be used throughout the present disclosure for convenience of a reader, but in no way these should limit the scope of the invention. Moreover, certain theories may be proposed and disclosed herein; however, in no way they, whether they are right or wrong, should limit the scope of the invention so long as the invention is practiced according to the present disclosure without regard for any particular theory or scheme of action.

All references cited throughout the specification are hereby incorporated by reference in their entirety for all purposes.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although the present disclosure has described in considerable detail certain embodiments, variations and refinements are possible and will become apparent to persons skilled in the art in light of the present teachings.

1. An animal feed pellet, comprising viable non-pathogenic E. coli bacteria incorporated into the pellet.

2. The animal feed pellet according to claim 1, wherein the bacteria is in an amount of at least 1×10⁵ CFU/g.

3. The animal feed pellet according to claim 1, wherein the viable non-pathogenic E. coli is embedded in a feed additive incorporated into the animal feed pellet.

4. The animal feed pellet according to claim 3, wherein the feed additive includes a matrix, wherein the matrix has a water activity (a_{w}) of ≤0.3 prior to incorporation into the pellet.

5. The animal feed pellet according to claim 4, wherein the matrix comprises a hydrocolloid-forming polysaccharide.

6. (canceled)

7. The animal feed pellet according to claim 5, wherein the hydrocolloid-forming polysaccharide is a first polysaccharide, wherein the feed additive further comprises a coating disposed on at least a portion of a surface thereof, and wherein the coating comprises a second polysaccharide which is different from the first polysaccharide.

8. The animal feed pellet according to claim 7, wherein the matrix comprises pores.

9. The animal feed pellet according to claim 7, wherein the coating comprises a particulate calcium-containing compound.

10. The animal feed pellet according to claim 9, wherein the calcium-containing compound includes calcium lactate.

11. The animal feed pellet according to claim 10, wherein the hydrocolloid-forming polysaccharide includes alginate.

12. The animal feed pellet according to claim 11, wherein the feed additive further includes a disaccharide.

13. The animal feed pellet according to 12, wherein the disaccharide includes sucrose, trehalose, or a combination thereof.

14. The animal feed pellet according to claim 13, wherein the feed additive further includes a salt of an amino acid.

15. The animal feed pellet according to claim 14, wherein the salt of the amino acid includes a salt of L-glutamic acid.

16-32. (canceled)

33. The animal feed pellet according to claim 15, wherein the second polysaccharide includes maltodextrin, dextran or a combination thereof.

34. The animal feed pellet according to claim 33, wherein the disaccharide and the second polysaccharide are present in a ratio disaccharide/second polysaccharide (wt. %/wt. %) of less than 10.

35. The animal feed pellet according to claim 11, wherein the coating further includes a disaccharide.

36. The animal feed pellet according to claim 35, wherein the disaccharide includes sucrose, trehalose, or a combination thereof.

37. The animal feed pellet according to claim 34, wherein the bacteria is in an amount of at least 1×10⁵ CFU/g.

38. The animal feed pellet according to claim 34, wherein the bacteria is in an amount of from 1×10⁵ to 1×10¹¹ CFU/g.
